(19) United States
(12) Patent Application Publication
(10) Pub. No.: US 2008/0187669 A1
(43) Pub. Date: Aug. 7, 2008

(54) Method For Waterproofing Lignocellulosic Materials

(75) Inventors: Arend Jouke Kingma, Ludwigshafen (DE); Andreas Fechtenkotter, Ludwigshafen (DE); Wolfgang Kasel, Nussloch (DE); Holger Militz, Bovenden (DE); Andreas Krause, Gottingen (DE); Carsten Mai, Gottingen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/912,594

(22) PCT Filed: Apr. 28, 2006
(86) PCT No.: PCT/EP2006/004016

§ 371 Date: Oct. 25, 2007

(30) Foreign Application Priority Data
May 2, 2005 (DE) 10 2005 020 390.6

(51) Int. Cl. B05D 3/10; C08F 2/16

(52) U.S. Cl. 427/342; 524/801

(57) ABSTRACT

(EN) The invention relates to a method for waterproofing lignocellulosic materials by impregnating the lignocellulosic material with a waterproofing agent, whereby the lignocellulosic material is impregnated with a hardenable aqueous composition before or during waterproofing, said composition containing at least one cross-linkable compound, selected from a) low-molecular weight compounds V, having at least two N-bonded groups of formula CH₂OH, wherein R=hydrogen or C₁-C₄ alkyl, and/or one 1,2-bis-hydroxyethan-1,2-diyl group, bridging two nitrogen atoms, β) precondensates of the compound V and & gammad;) reaction products or mixtures of the compound V with at least one alcohol, selected from C₁-C₆ alkanols, C₂-C₆ polyols and oligo-C₂-C₄-alkylene glycols.

The present invention relates to a process for the hydrophobizing of lignocellulose materials by impregnation of the lignocellulose material with a hydrophobizing agent and to the lignocellulose materials obtainable through this.

Lignocellulose materials, in particular wood but also other lignocellulose materials such as bamboo, natural fibers and the like, are of interest as building and construction materials for many applications. One disadvantage is that the natural durability of these materials is disadvantageously affected both by the effect of moisture and by changes in the moisture content in the surrounding atmosphere. The reason for this is the property of lignocellulose materials, on contact with water or in a moist atmosphere, of taking up water and of releasing it again in a dry atmosphere. The swelling or shrinking which accompanies this and the lack of dimensional stability of the materials associated with this is not only undesirable for many applications but can in the extreme case also result in destruction of the material by cracking. Moreover, these materials in the moist state are attacked by wood-decomposing or wood-discoloring microorganisms, which in many cases makes necessary the treating of these materials with fungicides or biocides. Apart from the cost aspect, such a treatment is also disadvantageous from ecological considerations.

The hydrophobizing of wood and other lignocellulose materials is a technique which has been well known for a long time for reducing the water uptake of these materials. Through this, on the one hand, the dimensional stability of these materials is improved and, on the other hand, the danger of attack by fungi or bacteria is reduced.

In addition to conventional wood preservatives based on creosotes, which, because of their inherent smell, their strong color and their potential carcinogenicity, are suitable only for a few end uses, vegetable oils, such as linseed oil, rapeseed oil, peanut oil, soybean oil and tall oil, in combination with biocidal and/or fungicidal wood preservatives, are extensively used today (see, e.g., DE-A-3008263 and A. Treu, H. Militz and S. Breyne, “Royal-Verfahren-Wissenschaftlicher Hintergrund und praktische Anwendung” [Royal Process—Scientific Background and Practical Application], COST E22 Conference in Reinbek, 2001 and the literature cited therein). One disadvantage is that on weathering, i.e. under the effect of moisture, e.g. through rain, and/or at elevated temperatures, such as can occur, e.g., with strong solar radiation, a portion of the oil together with the fungicidal/biocidal active substances can escape from the wood. Through this, the surface becomes sticky, the oil forms “noses” and the hydrophobizing effect therefore diminishes over time at local points.

The use of waxes for hydrophobizing wood has occasionally been reported, the waxes typically being used together with a hydrocarbon solvent (see, e.g., U.S. Pat. No. 3,832,463 and U.S. Pat. No. 4,612,255). The use of organic hydrocarbon solvents is, however, disadvantageous with regard to industrial and operational safety.

CA 2 179 001 in turn discloses a wood preservative with hydrophobizing effects which, in addition to a water-soluble wood preservative, such as chromated copper arsenates, comprises an aqueous emulsion of a low melting point wax, such as slack wax, and a cationic surface-active substance.

WO 00/41861 in turn discloses a process for the hydrophobizing of wood substrates in which the substrate is brought into contact with an aqueous dispersion of a wax at reduced pressure and a temperature greater than the melting point of the wax.

The hydrophobizing with use of waxes is also not always satisfactorily and frequently not sufficiently stable toward weathering. In addition, with large-scale wooden parts, i.e. with minimum dimensions of at least 1 cm, frequently no uniform distribution of the wax in the wood is achieved. In order to have to achieve a uniform distribution in the lignocellulose material, in particular in large-scale wooden articles, the impregnation with the wax dispersion has to be carried out while pressing strongly. Because of the shear forces which occur in this connection, the wax dispersions have a tendency to coagulate, which can result in blocking of the pores of the material and, in this way, hinders further penetration of the wax into the lignocellulose material. Many processes accordingly carry out an impregnation with wax dispersions at temperatures above the melting point of the wax, which can result in damage to the material.

It is accordingly an object of the present invention to make available a process for the hydrophobizing of lignocellulose materials, in particular of wood and especially of large-scale wooden articles, which overcomes the abovedescribed disadvantages of the state of the art. In particular, the process should make impregnation possible even at low temperatures, in particular of less than 50° C., in order to avoid damage to the wood.

It has surprisingly been found that the abovedescribed objects can be achieved and the problems of the state of the art can be solved by, before or during the hydrophobizing of the lignocellulose materials, impregnating with a curable aqueous composition comprising at least one crosslinkable compound chosen from
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol chosen from C₁-C₆-alkanols, C₂-C₆-polyols and oligo-C₂-C₄-alkylene glycols.

The invention accordingly relates to a process for the hydrophobizing of lignocellulose materials by impregnation of the lignocellulose material with a hydrophobizing agent, which comprises impregnating the lignocellulose material, before or during the hydrophobizing, with a curable aqueous composition comprising at least one crosslinkable compound chosen from
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol chosen from C₁-C₆-alkanols, C₂-C₆-polyols and oligo-C₂-C₄-alkylene glycols.

The lignocellulose materials impregnated by the process according to the invention are distinguished by a low uptake of water and moreover, in comparison with conventionally hydrophobized materials, do not show, or only show to a very much lesser extent, an exudation of the hydrophobizing agent on weathering, in particular at elevated temperatures. Moreover, the distribution of the hydrophobizing agent in the lignocellulose materials treated according to the invention, in particular in the case of large-size wooden moldings, is more uniform than in the application of conventional wax emulsions. The present invention consequently likewise relates to the lignocellulose materials obtainable according to the invention, in particular materials made of wood.

In a first step of the process according to the invention, the lignocellulose material, in particular wood, a derived product based on lignocellulose materials, e.g. a veneer lumber or a derived product formed from finely divided lignocellulose materials, such as shavings, fibers or strands, or a lignocellulose material for the preparation of such derived products, e.g. a veneer or finely divided lignocellulose material, is impregnated with an aqueous composition of the curable compound.

The finely divided lignocellulose materials include fibers, shavings, strands, chips, parings and the like. The term “veneers” is understood to mean flat thin wood materials with thicknesses ≦5 mm, in particular ≦1 mm. In particular, large-scale parts with minimum dimensions of greater than 1 mm, in particular >5 mm, especially ≧10 mm, and especially large-scale parts made of solid wood are impregnated in step a).

All wood types are suitable in principle as lignocellulose materials, in particular those which can absorb at least 30%, in particular at least 50%, of their dry weight of water and in particular those assigned to the impregnability categories 1 or 2 according to DIN 350-2. These include, for example, wood from conifers, such as pine (Pinus species), spruce, Douglas fir, larch, stone pine, fir (Abies species), grand fir, cedar or Swiss pine, and wood from deciduous trees, e.g. maple, hard maple, acacia, ayous, birch, pear, beech, oak, alder, aspen, ash, wild service, hazel, hornbeam, cherry, chestnut, lime, American walnut, poplar, olive, robinia, elm, walnut, gum, zebrano, willow, Turkey oak and the like. The advantages according to the invention come in useful in particular with the following woods: beech, spruce, pine, poplar, ash and maple.

The process according to the invention is also suitable for the impregnation of other lignocellulose materials other than wood, e.g. of natural fibrous materials, such as bamboo, bagasse, cotton stems, jute, sisal, straw, flax, coconut fibers, banana fibers, reeds, e.g. Chinese silvergrass, ramie, hemp, manila hemp, esparto (alfa grass), rice husks and cork.

The crosslinkable compounds, i.e. compounds V, their precondensates and their reaction products, are low molecular weight compounds or oligomers with low molecular weights which are present in the aqueous composition used generally in the completely dissolved form. The molecular weight of the crosslinkable compound is usually less than 400 daltons. It is assumed that the compounds, because of these properties, can penetrate into the cell walls of the wood and, on curing, improve the mechanical stability of the cell walls and reduce the swelling thereof brought about by water.

Examples of crosslinkable compounds are, without being limited thereto:
1,3-bis(hydroxymethyl)-4,5-dihydroxyimidazolidin-2-one (DMDHEU),
1,3-bis(hydroxymethyl)-4,5-dihydroxyimidazolidin-2-one modified with a C₁-C₆-alkanol, a C₂-C₆-polyol and/or an oligo-C₂-C₄-alkylene glycol (modified DMDHEU or mDMDHEU),
1,3-bis(hydroxymethyl)urea,
1,3-bis(methoxymethyl)urea,
1-hydroxymethyl-3-methylurea,
1,3-bis(hydroxymethyl)imidazolidin-2-one (dimethylolethyleneurea),
1,3-bis(hydroxymethyl)-1,3-hexahydropyrimidin-2-one (dimethylolpropyleneurea),
1,3-bis(methoxymethyl)-4,5-dihydroxyimidazolidin-2-one (DMeDHEU),
tetra(hydroxymethyl)acetylenediurea,
low molecular weight melamine-formaldehyde resins (MF resins), such as poly(hydroxymethyl)melamine with 2, 3, 4, 5 or 6 hydroxymethyl groups, and
low molecular weight melamine-formaldehyde resins (MF resins), such as poly(hydroxymethyl)melamine, which are modified with a C₁-C₆-alkanol, a C₂-C₆-polyol and/or an oligo-C₂-C₄-alkylene glycol (modified MF resin).

Aqueous compositions of compounds V, their precondensates and their reaction products are known per se, for example from WO 2004/033171, WO 2004/033170, K. Fisher et al., “Textile Auxiliaries—Finishing Agents,” Chapter 7.2.2, in Ullmann's Encyclopedia of Industrial Chemistry, 5th ed. on CD-ROM, Wiley-VCH, Weinheim, 1997, and the literature cited therein, U.S. Pat. No. 2,731,364, U.S. Pat. No. 2,930,715, H. Diem et al., “Amino-Resins”, Chapter 7.2.1 and 7.2.2, in Ullmann's Encyclopedia of Industrial Chemistry, 5th ed. on CD-ROM, Wiley-VCH, Weinheim, 1997, and the literature cited therein, Houben-Weyl E20/3, pp. 1811-1890, and are conventionally used as crosslinking agents for textile finishing. Reaction products of N-methylolated urea compounds V with alcohols, e.g. modified 1,3-bis(hydroxymethyl)-4,5-dihydroxyimidazolidin-2-one (mDMDHEU), are known, for example from U.S. Pat. No. 4,396,391 and WO 98/29393. In addition, compounds V and their reaction products and precondensates are commercially available.

In a preferred embodiment of the invention, the crosslinkable compound is chosen from urea compounds exhibiting, on each nitrogen atom of the urea unit, a CH₂OR group as defined above and the reaction products of these urea compounds with C₁-C₆-alkanols, C₂-C₆-polyols and/or oligoalkylene glycols. In particular, the crosslinkable compound is chosen from 1,3-bis(hydroxymethyl)-4,5-dihydroxyimidazolidin-2-one and a 1,3-bis(hydroxymethyl)-4,5-dihydroxyimidazolidin-2-one modified with a C₁-C₆-alkanol, a C₂-C₆-polyol and/or a polyalkylene glycol. Examples of polyalkylene glycols are in particular the oligo- and poly-C₂-C₄-alkylene glycols mentioned below.

mDMDHEU relates to reaction products of 1,3-bis(hydroxymethyl)-4,5-dihydroxy-imidazolidinon-2-one with a C₁-C₆-alkanol, a C₂-C₆-polyol, an oligoethylene glycol or mixtures of these alcohols. Suitable C₁₋₆-alkanols are, for example, methanol, ethanol, n-propanol, isopropanol, n-butanol and n-pentanol; methanol is preferred. Suitable polyols are ethylene glycol, diethylene glycol, 1,2- and 1,3-propylene glycol, 1,2-, 1,3-, and 1,4-butylene glycol, and glycerol. Examples of suitable polyalkylene glycols are in particular the oligo- and poly-C₂-C₄-alkylene glycols mentioned below. For the preparation of mDMDHEU, DMDHEU is mixed with the alkanol, the polyol or the polyalkylene glycol. In this connection, the monovalent alcohol, the polyol, or the oligo- or polyalkylene glycol are generally used in a ratio of in each case 0.1 to 2.0, in particular 0.2 to 2, molar equivalents, based on DMDHEU. The mixture of DMDHEU, the polyol or the polyalkylene glycol is generally reacted in water at temperatures of preferably 20 to 70° C. and a pH value of preferably 1 to 2.5, the pH value being adjusted after the reaction generally to a range of 4 to 8.

In an additional preferred embodiment of the invention, the crosslinkable compound is chosen from at least 2-times, e.g. 2-, 3-, 4-, 5- or 6-times, in particular a 3-times, methylolated melamine (poly(hydroxymethyl)melamine) and a poly(hydroxymethyl)melamine modified with a C₁-C₆-alkanol, a C₂-C₆-polyol and/or a polyalkylene glycol. Examples of polyalkylene glycols are in particular the oligo- and poly-C₂-C₄-alkylene glycols mentioned below.

The aqueous compositions to be applied according to the invention can also comprise one or more of the abovementioned alcohols, for example C₁-C₆-alkanols, C₂-C₆-polyols, oligo- and polyalkylene glycols or mixtures of these alcohols. Suitable C₁₋₆-alkanols are, for example, methanol, ethanol, n-propanol, isopropanol, n-butanol and n-pentanol; methanol is preferred. Suitable polyols are ethylene glycol, diethylene glycol, 1,2- and 1,3-propylene glycol, 1,2-, 1,3-, and 1,4-butylene glycol, and glycerol. Suitable oligo- and polyalkylene glycols are in particular oligo- and poly-C₂-C₄-alkylene glycols, especially homo- and cooligomers of ethylene oxide and/or of propylene oxide, which can be obtained, if appropriate, in the presence of low molecular weight initiators, e.g. aliphatic or cycloaliphatic polyols with at least 2 OH groups, such as 1,3-propanediol, 1,3- and 1,4-butanediol, 1,5-pentanediol, 1,6-hexanediol, glycerol, trimethylolethane, trimethylolpropane, erythritol, and pentaerythritol, as well as pentitols and hexitols, such as ribitol, arabitol, xylitol, dulcitol, mannitol and sorbitol, and also inositol, or aliphatic or cycloaliphatic polyamines with at least 2—NH₂ groups, such as diethylenetriamine, triethylenetetramine, tetraethylenepentamine, 1,3-propylenediamine, dipropylenetriamine, 1,4,8-triazaoctane, 1,5,8,12-tetraazadodecane, hexamethylenediamine, dihexamethylenetriamine, 1,6-bis(3-aminopropylamino)hexane, N-methyldipropylenetriamine or polyethylenimine, preference being given, among these, to diethylene glycol, triethylene glycol, di-, tri- and tetrapropylene glycol, low molecular weight Pluronic® brands from BASF (e.g., Pluronic® PE 3100, PE 4300, PE 4400, RPE 1720, RPE 1740).

The concentration of the crosslinkable compounds in the aqueous composition usually ranges from 1 to 60% by weight, frequently from 10 to 60% by weight and in particular from 15 to 50% by weight, based on the total weight of the composition. If the curable aqueous composition comprises one of the abovementioned alcohols, its concentration preferably ranges from 1 to 50% by weight, in particular from 5 to 40% by weight. The total amount of crosslinkable compound and alcohol usually constitutes 10 to 60% by weight and in particular 20 to 50% by weight of the total weight of the aqueous composition.

The aqueous composition used in step a) generally comprises at least one catalyst K which brings about the crosslinking of the compound V or of its reaction product or precondensate. Metal salts from the group of the metal halides, metal sulfates, metal nitrates, metal phosphates and metal tetrafluoroborates; boron trifluoride; ammonium salts from the group of the ammonium halides, ammonium sulfate, ammonium oxalate and diammonium phosphate; and organic carboxylic acids, organic sulfonic acids, boric acid, sulfuric acid and hydrochloric acid are generally suitable as catalysts K.

Examples of metal salts suitable as catalysts K are in particular magnesium chloride, magnesium sulfate, zinc chloride, lithium chloride, lithium bromide, aluminum chloride, aluminum sulfate, zinc nitrate and sodium tetrafluoroborate.

Examples of ammonium salts suitable as catalysts K are in particular ammonium chloride, ammonium sulfate, ammonium oxalate and diammonium phosphate.

Water-soluble organic carboxylic acids, such as maleic acid, formic acid, citric acid, tartaric acid and oxalic acid, furthermore benzenesulfonic acids, such as p-toluenesulfonic acid, but also inorganic acids, such as hydrochloric acid, sulfuric acid, boric acid and their mixtures, are also suitable in particular as catalysts K.

The catalyst K is preferably chosen from magnesium chloride, zinc chloride, magnesium sulfate, aluminum sulfate and their mixtures, magnesium chloride being particularly preferred.

The catalyst K will usually be added to the aqueous dispersion only shortly before the impregnation in step a). It is generally used in an amount of from 1 to 20% by weight, in particular from 2 to 10% by weight, based on the total weight of the curable constituents present in the aqueous composition. The concentration of the catalyst, based on the total weight of the aqueous dispersion, generally ranges from 0.1 to 10% by weight and in particular from 0.5 to 5% by weight.

The impregnation with the aqueous composition of the crosslinkable compound can be carried out in a way conventional per se, e.g. by immersion, by application of vacuum, if appropriate in combination with pressure, or by conventional application methods, such as spreading, spraying and the like. The impregnation method used in each case naturally depends on the dimensions of the material to be impregnated. Lignocellulose materials having small dimensions, such as shavings or strands, and also thin veneers, i.e. materials with a high ratio of surface area to volume, can be impregnated cheaply, e.g. by immersion or spraying, whereas lignocellulose materials having greater dimensions, in particular materials having a smallest extension of more than 5 mm, e.g. solid wood, moldings made of solid wood or derived timber products, are impregnated by application of pressure or vacuum, in particular by combined application of pressure and vacuum. The impregnation is advantageously carried out at a temperature of less than 50° C., e.g. in the range from 15 to 50° C.

The conditions of the impregnation are generally chosen so that the amount of curable constituents of the aqueous composition taken up is at least 1% by weight, preferably at least 5% by weight and in particular at least 10% by weight, based on the dry weight of the untreated material. The amount of curable constituents taken up can be up to 100% by weight, based on the dry weight of the untreated materials, and is frequently in the range from 1 to 60% by weight, preferably in the range from 5 to 50% by weight and in particular in the range from 10 to 40% by weight, based on the dry weight of the untreated material used. The moisture content of the untreated materials used for the impregnation is not critical and can, for example, be up to 100%. Here and subsequently, the term “moisture content” is synonymous with the term “residual moisture content” according to DIN 52183. In particular, the residual moisture is below the fiber saturation point of the lignocellulose material. It is frequently in the range from 1 to 80%, in particular 5 to 50%.

For immersion, the lignocellulose material, if appropriate after predrying, is immersed in a container comprising the aqueous composition. The immersion is preferably carried out over a period of time from a few seconds to 24 h, in particular 1 min to 6 h. The temperatures usually range from 15° C. to 50° C. Doing this, the lignocellulose material takes up the aqueous composition, it being possible for the amount of the non-aqueous constituents (i.e., curable constituents) taken up by the lignocellulose materials to be controlled by the concentration of these constituents in the aqueous composition, by the temperature and by the duration of treatment. The amount of constituents actually taken up can be determined and controlled by a person skilled in the art in a simple way via the increase in weight of the impregnated material and the concentration of the constituents in the aqueous dispersion. Veneers can, for example, be prepressed using press rolls, i.e. calenders, which are present in the aqueous impregnation composition. The vacuum occurring in the wood on relaxation then results in an accelerated uptake of aqueous impregnation composition.

The impregnation is advantageously carried out by combined application of reduced and increased pressure. For this, the lignocellulose material, which generally exhibits a moisture content in the range from 1% to 100%, is first brought into contact with the aqueous composition, e.g. by immersion in the aqueous composition, under a reduced pressure which is frequently in the range from 10 to 500 mbar and in particular in the range from 40 to 100 mbar. The duration is usually in the range from 1 min to 1 h. This is followed by a phase at increased pressure, e.g. in the range from 2 to 20 bar, in particular from 4 to 15 bar and especially from 5 to 12 bar. The duration of this phase is usually in the range from 1 min to 12 h. The temperatures are usually in the range from 15 to 50° C. Doing this, the lignocellulose material takes up the aqueous composition, it being possible for the amount of the non-aqueous constituents (i.e., curable constituents) taken up by the lignocellulose material to be controlled by the concentration of these constituents in the aqueous composition, by the pressure, by the temperature and by the duration of treatment. The amount actually taken up can also here be calculated via the increase in weight of the lignocellulose material.

Furthermore, the impregnation can be carried out by conventional methods for applying liquids to surfaces, e.g. by spraying or rolling or spreading. With regard to this, use is advantageously made of a material with a moisture content of not more than 50%, in particular not more than 30%, e.g. in the range from 12% to 30%. The application is usually carried out at temperatures in the range from 15 to 50° C. The spraying can be carried out in the usual way in all devices suitable for the spraying of flat or finely divided bodies, e.g. using nozzle arrangements and the like. For spreading or rolling, the desired amount of aqueous composition is applied to the flat material with rolls or brushes.

Subsequently, in step b), the crosslinkable constituents of the aqueous composition are cured. The curing can be carried out analogously to the methods described in the state of the art, e.g. according to the methods disclosed in WO 2004/033170 and WO 2004/033171.

Curing is typically carried out by treating the impregnated material at temperatures of greater than 80° C., in particular of greater than 90° C., e.g. in the range from 90 to 220° C. and in particular in the range from 100 to 200° C. The time required for the curing typically ranges from 10 min to 72 hours. Rather higher temperatures and shorter times can be used for veneers and finely divided lignocellulose materials. In the curing, not only are the pores in the lignocellulose material filled with the cured impregnating agent but crosslinking occurs between impregnating agent and the lignocellulose material itself.

If appropriate, it is possible, before the curing, to carry out a drying step, subsequently also referred to as predrying step. In this connection, the volatile constituents of the aqueous composition, in particular the water and excess organic solvents which do not react in the curing/crosslinking of the urea compounds, are partially or completely removed. The term “predrying” means that the lignocellulose material is dried to below the fiber saturation point, which, depending on the type of the lignocellulose material, is approximately 30% by weight. This predrying counteracts the danger of cracking. For small-scale lignocellulose materials, for example veneers, the predrying can be omitted. For wooden articles having greater dimensions, the predrying is advantageous, however. If a separate predrying is carried out, this is advantageously carried out at temperatures in the range from 20 to 80° C. Depending on the drying temperature chosen, partial or complete curing/crosslinking of the curable constituents present in the composition can occur. The combined predrying/curing of the impregnated materials is usually carried out by application of a temperature profile which may range from 50° C. to 220° C., in particular from 80 to 200° C.

The curing/drying can be carried out in a conventional fresh air-outgoing air system, e.g. a rotary drier. The predrying is preferably carried out in a way that the moisture content of the finely divided lignocellulose materials after the predrying is not more than 30%, in particular not more than 20%, based on the dry weight. It can be advantageous to take the drying/curing to a moisture content <10% and in particular <5%, based on the dry weight. The moisture content can be controlled in a simple way by means of the temperature, the duration and the pressure chosen in the predrying.

If appropriate, adhering liquid will be removed mechanically before the drying/curing.

For large-scale materials, it has proven worthwhile to fix these on drying/curing, e.g. in heating presses.

Subsequent to the impregnation with the aqueous composition of the crosslinkable compound and the curing step, if appropriate carried out, or during the impregnation, an impregnation with at least one hydrophobizing agent is carried out according to the invention. If the impregnation with the hydrophobizing agent should be carried out simultaneously with the impregnation with the aqueous composition of the crosslinkable compound, use is advantageously made of an aqueous composition which comprises both at least one hydrophobizing agent dispersed in the aqueous phase and the crosslinkable compound and, if appropriate, additional constituents, such as catalysts K, effect substances, the abovementioned alcohols and the like. Such compositions are novel and are likewise an object of the present invention.

Hydrophobizing agents are known in principle from the state of the art, e.g. from the state of the art mentioned at the beginning. In this connection, they are silicone oils, paraffin oils, vegetable oils, such as linseed oil, rapeseed oil, peanut oil, soybean oil and tall oil, and wax preparations, including solvent-based wax preparations and aqueous wax dispersions. The abovementioned hydrophobizing agents are frequently used in combination with biocidal and/or fungicidal wood preservatives in order to achieve an enhanced effectiveness.

According to a preferred embodiment of the invention, the hydrophobizing agent is a wax or a waxy polymer.

In particular, the hydrophobizing agent is an aqueous preparation, i.e. an aqueous emulsion or dispersion of one or more of the abovementioned hydrophobizing agents. In particular, it is an aqueous dispersion of a wax constituent, namely a wax or a waxy polymer or a mixture thereof. Subsequently, such aqueous preparations are also described as wax dispersions. The waxes or waxy polymers present in the aqueous dispersions are also described subsequently as wax constituent or wax component. A person skilled in the art understands the term “waxy polymers” as meaning polymers which resemble waxes in their pattern of properties, i.e. they are insoluble in water, can generally be melted without decomposition and exhibit a low viscosity in the molten state.

All conventional waxes and waxy polymers are suitable in principle as wax constituent in such dispersions, such as those known to a person skilled in the art from Ullmann's Encyclopedia of Industrial Chemistry, 5th ed. on CD-ROM, Wiley-VCH, Weinheim, 1997, chapter Waxes, and the literature cited therein.

Examples of suitable waxes or waxy polymers are natural waxes, e.g. animal waxes, such as beeswax and wool wax, mineral waxes, such as ozokerite or ceresin, petrochemical waxes, such as paraffin waxes, petrolatum waxes, microwaxes and slack wax, furthermore partially synthetic waxes, such as montan waxes and modified montan waxes, e.g. montan ester wax, amide wax, furthermore Sasol waxes, and synthetic waxes, such as Fischer-Tropsch waxes, polyolefin waxes, in particular polyethylene waxes, including waxy copolymers based on olefins, oxidized waxes, i.e. oxidation products of waxes or waxy polymers, e.g. oxidation products of Fischer-Tropsch waxes or polyolefin waxes, in particular of polyethylene waxes, including oxidation products of waxy copolymers based on olefins, and the like.

According to a first preferred embodiment of the wax dispersions used according to the invention, the wax constituent present therein exhibits a melting point or a softening point of at least 75° C., preferably of at least 80° C., frequently of at least 90° C. and in particular of at least 100C. The melting points valid here and subsequently are the values determined according to DIN ISO 3841 using DSC or from the cooling curve. According to a second embodiment of the invention, the wax constituent present in the wax dispersion exhibits a melting point of less than 75° C., preferably in the range from 30 to 70° C. and especially in the range from 35 to 60° C.

The concentration of the waxes or of the wax constituents in the aqueous dispersion typically ranges from 5 to 50% by weight, frequently from 8 to 40% by weight, in particular from 10 to 35% by weight and especially from 15 to 30% by weight, based on the total weight of the wax dispersion.

The wax constituents are present in wax dispersions as disperse phase, i.e. in the form of extremely fine particles or droplets. According to a preferred embodiment, these particles exhibit a mean particle size of less than 500 nm, in particular of less than 300 nm, especially of less than 200 nm and very particularly preferably of less than 150 nm, in particular if the wax constituent exhibits a melting point of at least 80° C. However, wax dispersions/emulsions with larger particle sizes can also be used in principle, e.g. up to 10 μm, e.g. 500 nm to 10 μm, in particular if a low melting point wax with a melting point of less than 75° C. is concerned.

The particle sizes given here are weight-average particle sizes, such as can be determined by dynamic light scattering. Methods for this are familiar to a person skilled in the art, for example from H. Wiese in D. Distler, Wässrige Polymerdispersionen [Aqueous Polymer Dispersions], Wiley-VCH, 1999, chapter 4.2.1, pp 40ff, and the literature cited therein, as well as H. Auweter, D. Horn, J. Colloid Interf. Sci., 105 (1985), 399, D. Lilge, D. Horn, Colloid Polym. Sci., 269 (1991), 704, or H. Wiese, D. Horn, J. Chem. Phys., 94 (1991), 6429.

The preparation of aqueous wax dispersions is known in principle and is carried out by dispersing the wax or the waxy polymer in the aqueous phase under application of strong shear forces and/or pressure, advantageously at elevated temperature, e.g. at temperatures of at least 50° C., preferably at temperatures of greater than 70° C. Waxes with a high melting point are dispersed in particular at temperatures of greater than 90° C., e.g. in the range from 90 to 200° C. and particularly preferably in the range from 100 to 160° C. In particular, the dispersing of the wax component, if it melts without decomposition, is carried out at temperatures greater than its melting point. Aqueous dispersions of waxes are also available commercially, for example under the trade names Poligen® WE range from BASF and AquaCer range from Byk-Cera (high melting point wax types with melting points or softening points of greater than 80° C.).

In one embodiment, the wax particles of the wax dispersion comprise at least one effect substance and/or one active substance. In this case, the active substance or the effect substance will advantageously first be dissolved or uniformly suspended in the wax and then the wax preparation thus obtained will be dispersed in the aqueous phase at the abovementioned temperatures.

The pressure applied in the dispersing is typically greater than 1 bar and frequently ranges from 1.5 to 40 and in particular from 2 to 20 bar.

If the wax component comprises carboxylic acid groups, which is preferred according to the invention, the emulsifying is advantageously carried out in the presence of a base. The base is advantageously used in an amount such that at least 40% and in particular at least 80% of the carboxylic acid groups present in the wax or waxy polymers are present in neutralized form.

Alkali metal hydroxides, such as sodium hydroxide or potassium hydroxide, alkaline earth metal hydroxides, such as calcium hydroxide, and also ammonia and amines are suitable in principle as bases. The amines are advantageously mono-, di- or trialkylamines with preferably 1 to 6 and in particular 1 to 4 carbon atoms in the alkyl radical, mono-, di- or trialkanolamines with preferably 2 to 6 carbon atoms in the hydroxyalkyl radical, monoalkyldialkanolamines and dialkylmonoalkanolamines with 1 to 12 and in particular 1 to 8 carbon atoms in the alkyl radical and 2 to 6 carbon atoms in the hydroxyalkyl radical, furthermore ethoxylated mono- and dialkylamines with preferably 1 to 20 carbon atoms in the alkyl radical and a degree of ethoxylation of preferably 2 to 60 and in particular 3 to 40. Preferred hydroxyalkyl in this connection is hydroxyethyl and 2-hydroxypropyl. Preference is given to those amines exhibiting at least one hydroxyalkyl group and/or one polyethylene oxide group. Examples of preferred amines are diethanolamine, triethanolamine, 2-amino-2-methylpropan-1-ol, dimethylethanolamine, diethylethanolamine, dimethylaminodiglycol, diethylaminodiglycol and diethylenetriamine.

In addition, emulsifiers can be added to promote the emulsifying. The emulsifiers can be nonionic, cationic or anionic, anionic emulsifiers and nonionic emulsifiers and mixtures of anionic and nonionic emulsifiers being preferred. Particular preference is given to nonionic emulsifiers and mixtures of nonionic emulsifiers with subsidiary amounts, generally less than 40% by weight and especially less than 20% by weight, based on the amount of emulsifiers, of anionic emulsifiers.

The anionic emulsifiers include, for example, carboxylates, in particular alkali metal, alkaline earth metal and ammonium salts of fatty acids, e.g. potassium stearate, which are usually also described as soaps; acyl glutamates; sarcosinates, e.g. sodium lauroyl sarcosinate; taurates; methylcelluloses; alkyl phosphates, in particular mono- and diphosphoric acid alkyl esters; sulfates, in particular alkyl sulfates and alkyl ether sulfates; sulfonates, other alkyl- and alkylarylsulfonates, in particular alkali metal, alkaline earth metal and ammonium salts of arylsulfonic acids and alkyl-substituted arylsulfonic acids, alkylbenzenesulfonic acids, such as, for example, lignin- and phenolsulfonic acid, naphthalene- and dibutylnaphthalenesulfonic acids, or dodecylbenzenesulfonates, alkylnaphthalenesulfonates, alkyl methyl ester sulfonates, condensation products of sulfonated naphthalene and derivatives thereof with formaldehyde, condensation products of naphthalenesulfonic acids, phenol- and/or phenolsulfonic acids with formaldehyde or with formaldehyde and urea, or mono- or dialkylsuccinic acid ester sulfonates; and protein hydrolysates and lignosulfite waste liquors. The abovementioned sulfonic acids are advantageously used in the form of their neutral or, if appropriate, basic salts.

The nonionic emulsifiers include, for example:
fatty alcohol alkoxylates and oxo alcohol alkoxylates, in particular ethoxylates and propoxylates with degrees of alkoxylation of usually 2 to 100 and in particular 3 to 50, e.g. alkoxylates of C₈-C₃₀-alkanols or alk(adi)enols, e.g. of isotridecyl alcohol, lauryl alcohol, oleyl alcohol or stearyl alcohol, and their C₁-C₄-alkyl ethers and C₁-C₄-alkyl esters, e.g. their acetates;
alkoxylated animal and/or vegetable fats and/or oils, for example corn oil ethoxylates, castor oil ethoxylates or tallow fat ethoxylates, with degrees of alkoxylation of usually 2 to 100 and in particular 3 to 50,
glycerol esters, such as, for example, glycerol monostearate,
fatty acid esters of polymeric alkoxylates, in particular of polyethylene oxides, with degrees of alkoxylation of 3 to 100, such as, e.g. PEG 300 oleate, stearate or laurate, as mono or diesters,
copolymeric alkoxylates of ethylene oxide and/or propylene oxide, e.g. the Pluronic® brands from BASF,
alkylphenol alkoxylates, such as, for example, ethoxylated isooctyl-, octyl- or nonylphenol, or tributylphenol polyoxyethylene ether, with degrees of alkoxylation of usually 2 to 100 and in particular 3 to 50,
fatty amine alkoxylates, fatty acid amide alkoxylates and fatty acid diethanolamide alkoxylates with degrees of alkoxylation of usually 2 to 100 and in particular 3 to 50, in particular their ethoxylates,
sugar surfactants, sorbitol esters, such as, for example, sorbitan fatty acid esters (sorbitan monooleate or sorbitan tristearate), polyoxyethylene sorbitan fatty acid esters, alkylpolyglycosides or N-alkylgluconamides,
alkyl methyl sulfoxides,
alkyldimethylphosphine oxides, such as, for example, tetradecyldimethylphosphine oxide.

Additional emulsifiers which should be mentioned here by way of example are perfluoroemulsifiers, silicone emulsifiers, phospholipids, such as, for example, lecithin or chemically modified lecithins, or amino acid emulsifiers, e.g. N-lauroyl glutamate.

Unless otherwise stated, the alkyl chains of the abovementioned emulsifiers are linear or branched radicals with usually 6 to 30 and in particular 8 to 20 carbon atoms.

Preferred nonionic emulsifiers are in particular alkoxylated and especially ethoxylated alkanols with 8 to 20 carbon atoms, e.g. ethoxylated nonanol, isononanol, decanol, 2-propylheptanol, tridecanol, lauryl alcohol, myristyl alcohol, cetyl alcohol, stearyl alcohol or C_{16/18} fatty alcohol mixtures, the degree of ethoxylation typically ranging from 5 to 50 and in particular from 6 to 30.

The amount of emulsifier depends, in a way known per se, on the type of the wax to be emulsified and will generally not exceed 15% by weight, in particular 10% by weight, based on the aqueous dispersion. At low acid numbers, in particular acid numbers of less than 100 mg KOH/g and especially of less than 50 mg KOH/g, e.g. in the range from 5 to 100 mg KOH/g and especially 10 to 50 mg KOH/g, emulsifiers will typically be used in an amount of 2 to 15% by weight and in particular of 3 to 10% by weight, based on the total weight of the aqueous wax dispersion, or of 5 to 50% by weight, in particular of 10 to 40% by weight, based on the emulsified wax component.

If the wax component exhibits an acid number of greater than 100 mg KOH/g, the waxes are frequently self-emulsifying and the proportion of emulsifier is advantageously less than 3% by weight, in particular less than 1% by weight and especially less than 0.5% by weight, based on the emulsified wax component.

As already mentioned, the wax component of the dispersion used according to the invention is, according to a preferred embodiment, a wax with a melting or softening point of at least 80° C. More advantageously, such a wax exhibits polar functional groups, e.g carboxyl groups, hydroxyl groups, aldehyde groups, keto groups, polyether groups or the like, which assist the dispersing of the wax. In particular, the wax exhibits neutralizable carboxyl groups. The wax is advantageously characterized by an acid number of at least 5 mg KOH/g and in particular in the range from 15 to 250 mg KOH/g.

Accordingly, the wax constituents of the wax dispersions to be applied according to the invention are advantageously montan waxes, including chemically modified montan waxes and montan ester waxes, amide waxes and polar polyolefin waxes.

The polar polyolefin waxes include the oxidation products of nonpolar polyolefin waxes, e.g. oxidation products of polyethylene waxes or of polypropylene waxes, which are also called oxidized polyolefin waxes, oxidized Fischer-Tropsch waxes, and copolymers of olefins, in particular of C₂-C₆-olefins, such as ethylene or propene, with monomers carrying oxygen groups, e.g. monoethylenically unsaturated C₃-C₆-monocarboxylic acids, such as acrylic acid or methacrylic acid, and, if appropriate, vinyl esters of aliphatic C₂-C₁₀-carboxylic acids, such as vinyl acetate or vinyl propionate, esters of monoethylenically unsaturated C₃-C₆-monocarboxylic acids with C₁-C₁₈-alkanols or C₅-C₁₂-cycloalkanols, in particular esters of acrylic acid or of methacrylic acid, such as methyl acrylate, ethyl acrylate, n-propyl acrylate, isopropyl acrylate, n-butyl acrylate, 2-butyl acrylate, tert-butyl acrylate, n-hexyl acrylate, 2-ethylhexyl acrylate, 3-propylheptyl acrylate, cyclopentyl acrylate, cyclohexyl acrylate and the corresponding esters of methacrylic acid. The polar polyolefin waxes furthermore include the oxidation products of the abovementioned olefin copolymers.

In a preferred embodiment, the wax component of the aqueous dispersion to be used according to the invention comprises at least one polar polyolefin wax to at least 50% by weight, in particular to at least 80% by weight and in particular to at least 90% by weight, based on the total weight of the wax constituents present in the dispersion. The polar polyolefin wax is chosen in particular from polar olefin copolymers and their oxidized products, the olefin copolymers being essentially formed from:
a) 50 to 99% by weight, in particular 55 to 95% by weight and especially 60 to 90% by weight of at least one C₂-C₆-olefin, in particular propene, ethene or their mixtures, especially ethene;
b) 1 to 50% by weight, in particular 5 to 40% by weight and especially 10 to 30% by weight of at least one monoethylenically unsaturated C₃-C₆-monocarboxylic acid, such as acrylic acid or methacrylic acid, and/or C₄-C₆-dicarboxylic acid, such as maleic acid, fumaric acid, itaconic acid or a mixture thereof, especially acrylic acid, methacrylic acid and/or maleic acid; and
c) 0 to 49% by weight, e.g. 5 to 49% by weight, in particular 0 to 40% by weight, e.g. 5 to 40% by weight, of one or more monoethylenically unsaturated monomers chosen from esters of monoethylenically unsaturated C₃-C₆-monocarboxylic acids with C₁-C₁₈-alkanols or C₅-C₁₂-cycloalkanols, diesters of monoethylenically unsaturated C₄-C₈-dicarboxylic acids with C₁-C₁₈-alkanols or C₅-C₁₂-cycloalkanols, in particular esters of acrylic acid or of methacrylic acid with C₁-C₁₈-alkanols or C₅-C₁₂-cycloalkanols, and from vinyl esters of aliphatic C₂-C₁₈-carboxylic acids, such as vinyl acetate or vinyl propionate.

The monomer proportions given here are in each case based on the total weight of the monomers constituting the polar polyolefin wax. This essentially means here that the polymers are formed to at least 95% by weight, in particular to at least 99% by weight and especially exclusively from the abovementioned monomers a), b) and, if appropriate, c). A person skilled in the art knows, though, that such polymers, aside from the monomer components, can even comprise, copolymerized, constituents of the polymerization catalyst (initiator).

Typically, the polar polyolefin waxes exhibit a weight-average molecular weight in the range from 1000 to 150 000 daltons, frequently in the range from 2000 to 120 000 daltons. In the case of waxes or waxy polymers with low to medium molecular weights which melt without decomposing, these are characterized by a melt viscosity at 140° C. in the range from 100 to 10 000 mm²/sec (DFG standard method C-IV7 (68)) or, with nonmelting waxy polymers, by a minimum melt flow index MFI of at least 1 (at 160° C. under a load of 325 g according to DIN 53753).

In an additional preferred embodiment, the wax component of the aqueous dispersion to be used according to the invention comprises at least one montan wax, including chemically modified montan waxes and montan ester waxes, to at least 50% by weight, in particular to at least 80% by weight and especially to at least 90% by weight, based on the total weight of the wax constituents present in the dispersion.

In an additional preferred embodiment, the wax component of the aqueous dispersion to be used according to the invention comprises at least one amide wax to at least 50% by weight, in particular to at least 80% by weight and especially to at least 90% by weight, based on the total weight of the wax constituents present in the dispersion.

In an additional preferred embodiment, the wax component of the aqueous dispersion to be used according to the invention comprises at least one oxidized polyolefin wax to at least 50% by weight, in particular to at least 80% by weight and especially to at least 90% by weight, based on the total weight of the wax constituents present in the dispersion.

The abovementioned wax constituents are common knowledge from the state of the art, e.g. from Ullman's Encyclopedia of Industrial Chemistry, 5^{th} ed. On CD-ROM, Wiley-VCH, Weinheim, 1997, chapter Waxes, in particular subchapter 3, “Montan Waxes”, and subchapter 6, “Polyolefin Waxes”, and from DE-A 3420168 and DE-A 3512564 (waxy copolymers), and from Kunststoffhandbuch [Plastics Handbook], Volume 4, pp 161 ff, Karl-HanserVerlag, 1969, and the literature cited therein, DE-A 2126725, DE 2035706, EP-A 28384, DE-OS 1495938, DE-OS 1520008, DE-OS 1570652, DE-OS 3112163, DE-OS 3720952, DE-OS 3720953, DE-OS 3238652 and WO97/41158. Such products are also available commercially, for example under the tradenames Luwax® OA range or Luwax® EAS range from BASF, Licowax PED from Clariant, AC3 . . . , and AC6 . . . ranges from Honeywell, and the AC5 . . . , ranges from Honeywell.

As already mentioned, the wax particles of the dispersion can, according to the invention, also comprise active or effect substances which bestow on the wood, in addition to its natural properties and the hydrophobizing achieved through the wax, additional properties such as color, improved weatherability or improved stability against attack by harmful organisms. The active or effect substances are typically low molecular weight organic compounds with molecular weights of less than 1000 daltons and typically of less than 500 daltons or inorganic salts or oxides of transition metals. The effect substances include colorants, such as pigments and dyes, and also antioxidants and UV stabilizers.

Suitable pigments comprise both organic pigments and inorganic pigments.

Examples of Colorants are
organic pigments, such as are mentioned, for example in WO 2004/035277, e.g.:
   Monoazo pigments, such as C.I. Pigment Brown 25, C.I. Pigment Orange 5,13, 36, 38, 64 and 67; C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4,63, 112, 146, 148,170, 175, 184, 185, 187, 191:1, 208, 210, 245, 247 and 251;
   C.I. Pigment Yellow 1, 3, 62, 65, 73, 74, 97, 120, 151, 154, 168, 181, 183 and 191; C.I. Pigment Violet 32;
   Disazo pigments, such as C.I. Pigment Orange 16, 34, 44 and 72; C.I. Pigment Red 144, 166, 214, 220, 221 and 242; C.I. Pigment Yellow 12, 13, 14, 16, 17, 81, 83, 106, 113,126,127, 155,174,176,180 and 188;
   Disazo condensation pigments, such as C.I. Pigment Yellow 93, 95 and 128;
   C.I. Pigment Red 144, 166, 214, 220, 242 and 262; C.I. Pigment Brown 23 and 41;
   Anthanthrone pigments, such as C.I. Pigment Red 168;
   Anthraquinone pigments, such as C.I. Pigment Yellow 147,177 and 199;
   C.I. Pigment Violet 31;
   Anthrapyrimidine pigments, such as C.I. Pigment Yellow 108;
   Quinacridone pigments, such as C.I. Pigment Orange 48 and 49; C.I. Pigment Red 122, 202, 206 and 209; C.I. Pigment Violet 19;
   Quinophthalone pigments, such as C.I. Pigment Yellow 138;
   Diketopyrrolopyrrole pigments, such as C.I. Pigment Orange 71, 73 and 81;
   C.I. Pigment Red 254, 255, 264, 270 and 272;
   Dioxazine pigments, such C.I. Pigment Violet 23 and 37; C.I. Pigment Blue 80;
   Flavanthrone pigments, such as C.I. Pigment Yellow 24;
   Indanthrone pigments, such as C.I. Pigment Blue 60 and 64;
   Isoindoline pigments, such as C.I. Pigmente Orange 61 and 69; C.I. Pigment Red 260; C.I. Pigment Yellow 139 and 185;
   Isoindolinone pigments, such as C.I. Pigment Yellow 109, 110 and 173;
   Isoviolanthrone pigments, such as C.I. Pigment Violet 31;
   Metal complex pigments, such as C.I. Pigment Red 257; C.I. Pigment Yellow 117, 129, 150, 153 and 177; C.I. Pigment Green 8; -Perinone pigments, such as: C.I. Pigment Orange 43; C.I. Pigment Red 194;
   Perylene pigments, such as C.I. Pigment Black 31 and 32; C.I. Pigment Red 123,149,178, 179,190 and 224; C.I. Pigment Violet 29;
   Phthalocyanine pigments, such as C.I. Pigment Blue 15, 15:1, 15:2, 15:3, 15:4, 15:6 and 16; C.I. Pigment Green 7 and 36;
   Pyranthrone pigments, such as C.I. Pigment Orange 51; C.I. Pigment Red 216;
   Pyrazoloquinazolone pigments, such as C.I. Pigment Orange 67; C.I. Pigment Red 251;
   Thioindigo pigments, such as C.I. Pigment Red 88 and 181; C.I. Pigment Violet 38;
   Triarylcarbonium pigments, such as C.I. Pigment Blue 1, 61 and 62;
   C.I. Pigment Green 1; C.I. Pigment Red 81, 81:1 and 169; and C.I. Pigment Violet 1, 2, 3 and 27;
   furthermore C.I. Pigment Black 1 (aniline black), C.I. Pigment Yellow 101 (aldazine yellow), C.I. Pigment Brown 22; and
inorganic coloring pigments, such as are mentioned, for example, in WO 2004/035277, e.g.: white pigments, such as titanium dioxide (C.I. Pigment White 6), zinc white, leaded zinc oxide; zinc sulfide, lithopone; black pigments, such as black iron oxide (C.I. Pigment Black 11), iron manganese black, spinel black (C.I. Pigment Black 27), carbon black (C.I. Pigment Black 7) and colored pigments, such as chromium oxide, hydrated chrome oxide green; chrome green (C.I. Pigment Green 48); cobalt green (C.I. Pigment Green 50), ultramarine green, cobalt blue (C.I. Pigment Blue 28 and 36; C.I. Pigment Blue 72); ultramarine blue; manganese blue, ultramarine violet; cobalt violet and manganese violet, red iron oxide (C.I. Pigment Red 101), cadmium sulfoselenide (C.I. Pigment Red 108), cerium sulfide (C.I. Pigment Red 265); molybdate red (C.I. Pigment Red 104), ultramarine red, brown iron oxide (C.I. Pigment Brown 6 and 7), mixed brown, spinel and corundum phases (C.I. Pigment Brown 29, 31, 33, 34, 35, 37, 39 and 40), chrome rutile yellow (C.I. Pigment Brown 24), chrome orange, cerium sulfide (C.I. Pigment Orange 75), yellow iron oxide (C.I. Pigment Yellow 42); nickel rutile yellow (C.I. Pigment Yellow 53; C.I. Pigment Yellow 157, 158, 159, 160, 161, 162, 163, 164 and 189); chromium rutile yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184).
Dyes: e.g., the dyes disclosed in DE-A 10245209 and the compounds described, according to the Colour Index, as disperse dyes and as solvent dyes, which are also described as dispersion dyes. A list of suitable dispersion dyes is found, for example, in Ullmann's Encyclopedia of Industrial Chemistry, 4th edition, Vol. 10, pp. 155-165 (see also Vol. 7, p. 585ff—Anthraquinone Dyes; Vol. 8, p. 244ff—Azo Dyes; Vol. 9, p. 313ff—Quinophthalone Dyes).

Particular reference is made herewith to this literature reference and to the compounds mentioned therein. Suitable dispersion dyes and solvent dyes according to the invention comprise the most varied categories of dyes with various chromophores, for example anthraquinone dyes, monoazo and disazo dyes, quinophthalone dyes, methine and azamethine dyes, naphthalimide dyes, naphthoquinone dyes and nitro dyes. Examples of suitable dispersion dyes according to the invention are the dispersion dyes of the following Colour Index list: C.I. Disperse Yellow 1-228, C.I. Disperse Orange 1-148, C.I. Disperse Red 1-349, C.I. Disperse Violet 1-97, C.I. Disperse Blue 1-349, C.I. Disperse Green 1-9, C.I. Disperse Brown 1-21, C.I. Disperse Black 1-36. Examples of suitable solvent dyes according to the invention are the compounds of the following Colour Index list: C.I. Solvent Yellow 2-191, C.I. Solvent Orange 1-113, C.I. Solvent Red 1-248, C.I. Solvent Violet 2-61, C.I. Solvent Blue 2-143, C.I. Solvent Green 1-35, C.I. Solvent Brown 1-63, C.I. Solvent Black 3-50. Suitable dyes according to the invention are furthermore derivatives of naphthalene, of anthracene, of perylene, of terylene or of quarterylene, and diketopyrrolopyrrole dyes, perinone dyes, coumarin dyes, isoindoline and isoindolinone dyes, porphyrin dyes, and phthalocyanine and naphthalocyanine dyes.

UV absorbers, antioxidants and/or stabilizers can also be used as effect substances. Examples of UV absorbers are the compounds from the groups a) to g) listed below. Examples of stabilizers are the compounds from the groups i) to q) listed below:
a) 4,4-diarylbutadienes,
b) cinnamates,
c) benzotriazoles,
d) hydroxybenzophenones,
e) diphenylcyanoacrylates,
f) oxamides (oxalic acid diamides),
g) 2-phenyl-1,3,5-triazines,
h) antioxidants,
i) sterically hindered amines,
j) metal deactivators,
k) phosphites and phosphonites,
l) hydroxylamines,
m) nitrones,
n) amine oxides,
o) benzofuranones and indolinones,
p) thiosynergists, and
q) peroxide-destroying compounds.

The group a) of 4,4-diarylbutadienes includes, for example, compounds of the formula A.

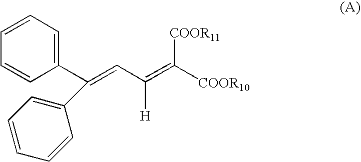

The compounds are known from EP-A-916 335. The R₁₀ and/or R₁₁ substituents preferably represent C₁-C₈-alkyl and C₅-C₈-cycloalkyl.

The group b) of the cinnamates includes, for example, isoamyl 4-methoxycinnamate, 2-ethylhexyl 4-methoxycinnamate, methyl α-(methoxycarbonyl)cinnamate, methyl α-cyano-β-methyl-β-methoxycinnamate, butyl α-cyano-β-methyl-β-methoxycinnamate and methyl α-(methoxycarbonyl)-β-methoxycinnamate.

The group c) of the benzotriazoles includes, for example, 2-(2′-hydroxyphenyl)benzotriazoles, such as 2-(2′-hydroxy-5′-methylphenyl)benzotriazole, 2-(3′,5′-di(tert-butyl)-2′-hydroxyphenyl)benzotriazole, 2-(5′-(tert-butyl)-2′-hydroxyphenyl)benzotriazole, 2-(2′-hydroxy-5′-(1,1,3,3-tetramethylbutyl)phenyl)benzotriazole, 2-(3′,5′-di(tert-butyl)-2′-hydroxyphenyl)-5-chlorobenzotriazole, 2-(3′-(tert-butyl)-2′-hydroxy-5′-methylphenyl)-5-chlorobenzotriazole, 2-(3′-(sec-butyl)-5′-(tert-butyl)-2′-hydroxyphenyl)benzotriazole, 2-(2′-hydroxy-4′-octyloxyphenyl)benzotriazole, 2-(3′,5′-di(tert-amyl)-2′-hydroxyphenyl)benzotriazole, 2-(3′,5′-bis(α,α-dimethylbenzyl)-2′-hydroxyphenyl)benzotriazole, 2-(3′-(tert-butyl)-2′-hydroxy-5′-(2-octyloxycarbonylethyl)phenyl)-5-chlorobenzotriazole, 2-(3′-(tert-butyl)-5′-[2-(2-ethylhexyloxycarbonyl)ethyl]-2′-hydroxyphenyl)-5-chlorobenzotriazole, 2-(3′-(tert-butyl)-2′-hydroxy-5′-(2-methoxycarbonylethyl)phenyl)-5-chlorobenzotriazole, 2-(3′-(tert-butyl)-2′-hydroxy-5′-(2-methoxycarbonylethyl)phenyl)benzotriazole, 2-(3′-(tert-butyl)-2′-hydroxy-5′-(2-octyloxycarbonylethyl)phenyl)benzotriazole, 2-(3′-(tert-butyl)-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-(tert-butyl)-2′-hydroxy-5′-(2-isooctyloxycarbonylethyl)phenyl)benzotriazole, 2,2′-methylenebis[4-(1,1,3,3-tetramethylbutyl)-6-(benzotriazol-2-yl)phenol], the product of the esterification of 2-[3′-(tert-butyl)-5′-(2-methoxycarbonylethyl)-2′-hydroxyphenyl]-2H-benzotriazole with polyethylene glycol 300, [R—CH₂CH₂—COO(CH₂)₃]₂ with R=3′-(tert-butyl)-4′-hydroxy-5′-(2H-benzotriazol-2-yl)phenyl, and mixtures thereof.

The group d) of the hydroxybenzophenones includes, for example, 2-hydroxybenzophenones, such as 2-hydroxy-4-methoxybenzophenone, 2,2′-dihydroxy-4-methoxybenzophenone, 2,4-dihydroxybenzophenone, 2,2′,4,4′-tetrahydroxybenzophenone, 2,2′-dihydroxy-4,4′-dimethoxybenzophenone, 2,2′-dihydroxy-4,4′-dimethoxybenzophenone, 2-hydroxy-4-(2-ethylhexyloxy)benzophenone, 2-hydroxy-4-(n-octyloxy)benzophenone, 2-hydroxy-4-methoxy-4′-methylbenzophenone, 2-hydroxy-3-carboxybenzophenone, 2-hydroxy-4-methoxybenzophenone-5-sulfonic acid and its sodium salt, and 2,2′-dihydroxy-4,4′-dimethoxybenzophenone-5,5′-disulfonic acid and its sodium salt.

The group e) of the diphenylcyanoacrylates includes, for example, ethyl 2-cyano-3,3-diphenylacrylate, which is available, for example, commercially under the name Uvinul® 3035 from BASF AG, Ludwigshafen, 2-ethylhexyl 2-cyano-3,3-diphenylacrylate, which is available, for example, commercially as Uvinul® 3039 from BASF AG, Ludwigshafen, and 1,3-bis[(2′-cyano-3′,3′-diphenylacryloyl)oxy]-2,2-bis{[(2′-cyano-3′,3′-diphenylacryloyl)oxy]methyl}propane, which is available, for example, commercially under the name Uvinul® 3030 from BASF AG, Ludwigshafen.

The group f) of the oxamides includes, for example, 4,4′-dioctyloxyoxanilide, 2,2′-diethoxyoxanilide, 2,2′-dioctyloxy-5,5′-di(tert-butyl)oxanilide, 2,2′-didodecyloxy-5,5′-di(tertbutyl)oxanilide, 2-ethoxy-2′-ethyloxanilide, N,N′-bis(3-dimethylaminopropyl)oxamide, 2-ethoxy-5-(tert-butyl)-2′-ethyloxanilide and its mixture with 2-ethoxy-2′-ethyl-5,4′-di(tert-butyl)oxanilide, and also mixtures of ortho- and para-methoxy-disubstituted oxanilides and mixtures of ortho- and para-ethoxy-disubstituted oxanilides.

The group g) of the 2-phenyl-1,3,5-triazines includes, for example, 2-(2-hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-(butyloxy)propoxy)phenyl]-4,6-bis(2,4-dimethylphenyl)-1,3,5-triazine, 2-[2-hydroxy-4-(2-hydroxy-3-(octyloxy)propoxy)phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-(dodecyloxy)propoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

The group h) of the antioxidants comprises, for example: alkylated monophenols, such as, for example, 2,6-di(tert-butyl)-4-methylphenol, 2-(tert-butyl)-4,6-dimethylphenol, 2,6-di(tert-butyl)-4-ethylphenol, 2,6-di(tert-butyl)-4-(nbutyl)phenol, 2,6-di(tert-butyl)-4-isobutylphenol, 2,6-dicyclopentyl-4-methylphenol, 2-α-methylcyclohexyl)-4,6-dimethylphenol, 2,6-dioctadecyl-4-methylphenol, 2,4,6-tricyclohexylphenol, 2,6-di(tert-butyl)-4-methoxymethylphenol, unbranched nonylphenols or nonylphenols which are branched in the side chain, such as, for example, 2,6-dinonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

Alkylthiomethylphenols, such as, for example, 2,4-dioctylthiomethyl-6-(tertbutyl)phenol, 2,4-dioctylthiomethyl-6-methylphenol, 2,4-dioctylthiomethyl-6-ethylphenol and 2,6-didodecylthiomethyl-4-nonylphenol.

Hydroquinones and alkylated hydroquinones, such as, for example, 2,6-di(tert-butyl)-4-methoxyphenol, 2,5-di(tert-butyl)hydroquinone, 2,5-di(tert-amyl)hydroquinone, 2,6-diphenyl-4-octadecyloxyphenol, 2,6-di(tert-butyl)hydroquinone, 2,5-di(tert-butyl)-4-hydroxyanisole, 3,5-di(tert-butyl)-4-hydroxyanisole, 3,5-di(tert-butyl)-4-hydroxyphenyl stearate and bis(3,5-di(tert-butyl)-4-hydroxyphenyl) adipate.

Tocopherols, such as, for example, α-tocopherol, β-tocopherol, γ-tocopherol, δ-tocopherol and mixtures thereof (vitamin E).

Hydroxylated thiodiphenyl ethers, such as, for example, 2,2′-thiobis(6-(tert-butyl)-4-methylphenol), 2,2′-thiobis(4-octylphenol), 4,4′-thiobis(6-(tert-butyl)-3-methylphenol), 4,4′-thiobis(6-(tert-butyl)-2-methylphenol), 4,4′-thiobis(3,6-di(sec-amyl)phenol) and 4,4′-bis(2,6-dimethyl-4-hydroxyphenyl) disulfide.

Alkylidenebisphenols, such as, for example, 2,2′-methylenebis(6-(tert-butyl)-4-methylphenol), 2,2′-methylenebis(6-(tert-butyl)-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di(tert-butyl)phenol), 2,2′-ethylidenebis(4,6-di(tert-butyl)phenol), 2,2′-ethylidenebis(6-(tert-butyl)-4-isobutylphenol), 2,2′-methylenebis[6-(a-methylbenzyl)-4-nonylphenol], 2,2′-methylenebis[6-(α,α-dimethylbenzyl)-4-nonylphenol], 4,4′-methylenebis(2,6-di(tertbutyl)phenol), 4,4′-methylenebis(6-(tert-butyl)-2-methylphenol), 1,1-bis(5-(tert-butyl)-4-hydroxy-2-methylphenyl)butane, 2,6-bis(3-(tert-butyl)-5-methyl-2-hydroxybenzyl)-4-methylphenol, 1,1,3-tris(5-(tert-butyl)-4-hydroxy-2-methylphenyl)butane, 1,1-bis(5-(tert-butyl)-4-hydroxy-2-methylphenyl)-3-(n-dodecylmercapto)butane, ethylene glycol bis[3,3-bis(3-(tert-butyl)-4-hydroxyphenyl)butyrate], bis(3-(tert-butyl)-4-hydroxy-5-methylphenyl)dicyclopentadiene, bis[2-(3′-(tert-butyl)-2-hydroxy-5-methylbenzyl)-6-(tert-butyl)-4-methylphenyl] terephthalate, 1,1-bis(3,5-dimethyl-2-hydroxyphenyl)butane, 2,2-bis(3,5-di(tert-butyl)-4-hydroxyphenyl)propane, 2,2-bis(5-(tert-butyl)-4-hydroxy-2-methylphenyl)-4-(n-dodecylmercapto)butane and 1,1,5,5-tetra(5-(tert-butyl)-4-hydroxy-2-methylphenyl)pentane.

Benzyl compounds, such as, for example, 3,5,3′,5′-tetra(tert-butyl)-4,4′-dihydroxydibenzyl ether, octadecyl 4-hydroxy-3,5-dimethylbenzylmercaptoacetate, tridecyl 4-hydroxy-3,5-di(tert-butyl)benzylmercaptoacetate, tris(3,5-di(tert-butyl)-4-hydroxybenzyl)amine, 1,3,5-tri(3,5-di(tert-butyl)-4-hydroxybenzyl)-2,4,6-trimethylbenzene, di(3,5-di(tert-butyl)-4-hydroxybenzyl) sulfide, isooctyl 3,5-di(tert-butyl)-4-hydroxybenzylmercaptoacetate, bis(4-(tert-butyl)-3-hydroxy-2,6-dimethylbenzyl)dithioterephthalate, 1,3,5-tris(3,5-di(tert-butyl)-4-hydroxybenzyl) isocyanurate, 1,3,5-tris(4-(tert-butyl)-3-hydroxy-2,6-dimethylbenzyl)isocyanurate, 3,5-di(tert-butyl)-4-hydroxybenzyl dioctadecyl phosphate and 3,5-di(tert-butyl)-4-hydroxybenzyl monoethyl phosphate, calcium salt.

Hydroxybenzylated malonates, such as, for example, dioctadecyl 2,2-bis(3,5-di(tert-butyl)-2-hydroxybenzyl)malonate, dioctadecyl 2-(3-(tert-butyl)-4-hydroxy-5-methylbenzyl)malonate, didodecylmercaptoethyl 2,2-bis(3,5-di(tert-butyl)-4-hydroxybenzyl)malonate and bis[4-(1,1,3,3-tetramethylbutyl)phenyl]2,2-bis(3,5-di(tert-butyl)-4-hydroxybenzyl)malonate.

Hydroxybenzyl aromatic compounds, such as, for example, 1,3,5-tris(3,5-di(tert-butyl)-4-hydroxybenzyl)-2,4,6-trimethylbenzene, 1,4-bis(3,5-di(tert-butyl)-4-hydroxybenzyl)-2,3,5,6-tetramethylbenzene and 2,4,6-tris(3,5-di(tert-butyl)-4-hydroxybenzyl)phenol.

Triazine compounds, such as, for example, 2,4-bis(octylmercapto)-6-(3,5-di(tert-butyl)-4-hydroxyanilino)-1,3,5-triazine, 2-octylmercapto-4,6-bis(3,5-di(tert-butyl)-4-hydroxyanilino)-1,3,5-triazine, 2-octylmercapto-4,6-bis(3,5-di(tert-butyl)-4-hydroxyphenoxy)-1,3,5-triazine, 2,4,6-tris(3,5-di(tert-butyl)-4-hydroxyphenoxy)-1,3,5-triazine, 1,3,5-tris(3,5-di(tert-butyl)-4-hydroxybenzyl) isocyanurate, 1,3,5-tris(4-(tert-butyl)-3-hydroxy-2,6-dimethylbenzyl) isocyanurate, 2,4,6-tris(3,5-di(tert-butyl)-4-hydroxyphenylethyl)-1,3,5-triazine, 1,3,5-tris(3,5-di(tert-butyl)-4-hydroxyphenylpropionyl)-hexahydro-1,3,5-triazine and 1,3,5-tris(3,5-dicyclohexyl-4-hydroxybenzyl)isocyanurate.

Benzylphosphonates, such as, for example, dimethyl 2,5-di(tert-butyl)-4-hydroxybenzylphosphonate, diethyl 3,5-di(tert-butyl)-4-hydroxybenzylphosphonate ((3,5-bis(1,1-dimethylethyl)-4-hydroxyphenyl)methylphosphonic acid diethyl ester), dioctadecyl 3,5-di(tert-butyl)-4-hydroxybenzylphosphonate, dioctadecyl 5-(tert-butyl)-4-hydroxy-3-methylbenzylphosphonate and calcium salt of 3,5-di(tert-butyl)-4-hydroxybenzylphosphonic acid monoethyl ester.

Acylaminophenols, such as, for example, lauric acid 4-hydroxyanilide, stearic acid 4-hydroxyanilide, 2,4-bisoctylmercapto-6-(3,5-di(tert-butyl)-4-hydroxyanilino)-s-triazine and octyl N-(3,5-di(tert-butyl)-4-hydroxyphenyl)carbamate.

Esters of β-(3,5-di(tert-butyl)-4-hydroxyphenyl)propionic acid with mono- or polyvalent alcohols, such as, e.g., with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of β-(5-(tert-butyl)-4-hydroxy-3-methylphenyl)propionic acid with mono- or polyvalent alcohols, such as, e.g., with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of β-(3,5-dicyclohexyl-4-hydroxyphenyl)propionic acid with mono- or polyvalent alcohols, such as, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of 3,5-di(tert-butyl)-4-hydroxyphenylacetic acid with mono- or polyvalent alcohols, such as, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Amides of β-(3,5-di(tert-butyl)-4-hydroxyphenyl)propionic acid, such as, e.g., N,N′-bis(3,5-di(tert-butyl)-4-hydroxyphenylpropionyl)hexamethylenediamine, N,N′-bis(3,5-di(tert-butyl)-4-hydroxyphenylpropionyl)trimethylenediamine, N,N′-bis(3,5-di(tert-butyl)-4-hydroxyphenylpropionyl)hydrazine and N,N′-bis[2-(3-[3,5-di(tert-butyl)-4-hydroxyphenyl]propionyloxy)ethyl]oxamide (e.g. Naugard®XL-1 from Uniroyal).

Ascorbic acid (vitamin C).

Aminic antioxidants, such as, for example, N,N′-diisopropyl-p-phenylenediamine, N,N′-di(sec-butyl)-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-tolylsulfamoyl)diphenylamine, N,N′-dimethyl-N,N′-di(sec-butyl)p-phenylenediamine, diphenylamine, N-allyidiphenylamine, 4-isopropoxydiphenylamine, N-phenyl-1-naphthylamine, N-(4-(tert-octyl)phenyl)-1-naphthylamine, N-phenyl-2-naphthylamine, octylated diphenylamine, for example p,p′-di(tert-octyl)diphenylamine, 4-(n-butylamino)phenol, 4-butyrylaminophenol, 4-nonanoylaminophenol, 4-dodecanoylaminophenol, 4-octadecanoylaminophenol, bis(4-methoxyphenyl)amine, 2,6-di(tert-butyl)-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, mixture of mono- and dialkylated tert-butyl/tert-octyldiphenylamines, mixture of mono- and dialkylated nonyldiphenylamines, mixture of mono- and dialkylated dodecyldiphenylamines, mixture of mono- and dialkylated isopropyl/isohexyldiphenylamines, mixture of mono- and dialkylated tert-butyldiphenylamines, 2,3-dihydro-3,3-dimethyl-4H-1,4-benzothiazine, phenothiazine, mixture of mono- and dialkylated tert-butyl/tert-octylphenothiazines, mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl) sebacate, 2,2,6,6-tetramethylpiperidin-4-one, 2,2,6,6-tetramethylpiperidin-4-ol, the dimethyl succinate polymer with 4-hydroxy-2,2,6,6-tetramethyl-1-piperidinethanol [CAS number 65447-77-0] (for example Tinuvin®) 622 from Ciba Specialty Chemicals Inc.) and polymer based on 2,2,4,4-tetramethyl-7-oxa-3,20-diazadispiro[5.1.11.2]henicosan-21-one and epichlorhydrin [CAS-No.: 202483-55-4] (for example Hostavin®30 from Ciba Specialty Chemicals Inc.).

The group i) of the sterically hindered amines includes, for example, 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl) sebacate, bis(1-octyloxy-2,2,6,6-tetramethyl-4-piperidyl)sebacate, bis(1,2,2,6,6-pentamethyl-4-piperidyl)(n-butyl)(3,5-di(tert-butyl)-4-hydroxybenzyl)malonate ((n-butyl)(3,5-di(tert-butyl)-4-hydroxybenzyl)malonic acid bis(1,2,2,6,6-pentamethylpiperidyl)ester), condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylenediamine and 4-(tert-octylamino)-2,6-dichloro-1,3,5-triazine, tris(2,2,6,6-tetramethyl-4-piperidyl) nitrilotriacetate, tetrakis(2,2,6,6-tetramethyl-4-piperidyl) 1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl) 2-(n-butyl)-2-(2-hydroxy-3,5-di(tert-butyl)benzyl)malonate, 3-(n-octyl)-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl) succinate, linear or cyclic condensation products of N,N′-bis(2,2,6,6-tetramethyl-4-piperidyl)hexamethylenediamine and 4-morpholino-2,6-dichloro-1,3,5-triazine, condensation product of N,N′-bis(2,2,6,6-tetramethyl-4-piperidyl)hexamethylenediamine and formic acid ester (CAS No. 124172-53-8, e.g. Uvinul® 4050H from BASF AG, Ludwigshafen), condensation product of 2-chloro-4,6-bis(4-(n-butyl)amino-2,2,6,6-tetramethylpiperidyl)-1,3,5-triazine and 1,2-bis(3-aminopropylamino)ethane, condensation product of 2-chloro-4,6-di(4-(n-butyl)amino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, condensation product of N,N′-bis(2,2,6,6-tetramethyl-4-piperidyl)hexamethylenediamine and 4-cyclohexylamino-2,6-dichloro-1,3,5-triazine, condensation product of 1,2-bis(3-aminopropylamino)ethane and 2,4,6-trichloro-1,3,5-triazine, as well as 4-butylamino-2,2,6,6-tetramethylpiperidine (CAS Reg. No. [136504-96-6]); N-(2,2,6,6-tetramethyl-4-piperidyl)-(n-dodecyl)succinimide, N-(1,2,2,6,6-pentamethyl-4-piperidyl)-(n-dodecyl)succinimide, 2-undecyl-7,7,9,9-tetramethyl-1-oxa-3,8-diaza-4-oxospiro[4.5]decane, reaction product of 7,7,9,9-tetramethyl-2-cycloundecyl-1-oxa-3,8-diaza-4-oxospiro[4.5]decane and epichlorohydrin, 1,1-bis(1,2,2,6,6-pentamethyl-4-piperidyloxycarbonyl)-2-(4-methoxyphenyl)ethene, N,N′-bisformyl-N,N′-bis(2,2,6,6-tetramethyl-4-piperidyl)hexamethylenediamine, diester of 4-methoxymethylenemalonic acid with 1,2,2,6,6-pentamethyl-4-hydroxypiperidine, poly[methylpropyl-3-oxo-4-(2,2,6,6-tetramethyl-4-piperidyl)]siloxane, reaction product of maleic anhydride/α-olefin copolymer and 2,2,6,6-tetramethyl-4-aminopiperidine or 1,2,2,6,6-pentamethyl-4-aminopiperidine, copolymers of (partially) N-(piperidin-4-yl)-substituted maleimide and a mixture of α-olefins, such as, e.g. Uvinul® 5050H (BASF AG), 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine and a carbon radical of t-amyl alcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl) sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, bis(1-(2-hydroxy-2-methylpropoxy)-2,2,6,6-tetramethylpiperidin-4-yl) glutarate, 2,4-bis{N-[1-(2-hydroxy-2-methylpropoxy)-2,2,6,6-tetramethylpiperidin-4-yl]-N-butylamino}-6-(2-hydroxyethylamino)-s-triazine, N,N′-bisformyl-N,N′-bis(1,2,2,6,6-pentamethyl-4-piperidyl)hexamethylenediamine, hexahydro-2,6-bis(2,2,6,6-tetramethyl-4-piperidyl)-1H,4H,5H,8H-2,3a,4a,6,7a,8a-hexaazacyclopenta[def]fluorene-4,8-dione (e.g. Uvinul® 4049 from BASF AG, Ludwigshafen), poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]] [CAS No. 71878-19-8], 1,3,5-triazine-2,4,6-triamine, N,N,N′,N-tetrakis(4,6-di(butyl(N-methyl-2,2,6,6-tetramethylpiperidin-4-yl)amino)triazin-2-yl)-4,7-diazadecane-1,10-diamine (CAS No. 106990-43-6) (e.g. Chimassorb 119 from Ciba Specialty Chemicals Inc.).

The group j) of the metal deactivators includes, for example, N,N′-diphenyloxamide, N-salicylal-N′-salicyloylhydrazine, N,N′-bis(salicyloyl)hydrazine, N,N′-bis(3,5-di(tert-butyl)-4-hydroxyphenylpropionyl)hydrazine, 3-salicyloylamino-1,2,4-triazole, bis(benzylidene)oxalic acid dihydrazide, oxanilide, isophthalic acid dihydrazide, sebacic acid bisphenylhydrazide, N,N′-diacetyladipodihydrazide, N,N′-bis(salicyloyl)oxalodihydrazide or N,N′-bis(salicyloyl)thiopropionodihydrazide.

The group k) of the phosphites and phosphonites includes, for example, triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di(tert-butyl)phenyl) phosphite, diisodecyl pentaerythritol diphosphite, bis(2,4-di(tert-butyl)phenyl) pentaerythritol diphosphite, bis(2,6-di(tert-butyl)-4-methylphenyl) pentaerythritol diphosphite, diisodecyl pentaerythritol diphosphite, bis(2,4-di(tert-butyl)-6-methylphenyl) pentaerythritol diphosphite, bis(2,4,6-tris(tert-butyl)phenyl) pentaerythritol diphosphite, tristearyl sorbitol triphosphite, tetrakis(2,4-di(tert-butyl)phenyl) 4,4′-biphenylenediphosphonite, 6-isooctyloxy-2,4,8,10-tetra(tert-butyl)dibenzo[d,f][1,3,2]dioxaphosphepin, 6-fluoro-2,4,8,10-tetra(tert-butyl)-12-methyldibenzo[d,g][1,3,2]dioxaphosphocin, bis(2,4-di(tert-butyl)-6-methylphenyl)methyl phosphite, bis(2,4-di(tert-butyl)-6-methylphenyl)ethyl phosphite, 2,2′,2″-nitrilo[triethyl tris(3,3′,5,5′-tetra(tert-butyl)-1,1′-biphenyl-2,2′-diyl) phosphite] and 2-ethylhexyl (3,3′,5,5′-tetra(tert-butyl)-1,1′-biphenyl-2,2′-diyl) phosphite.

The group l) of the hydroxylamines includes, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecyl-hydroxylamine, N-hexadecyl-N-octadecylhydroxylamine, N-heptadecyl-N-octadecylhydroxylamine, N-methyl-N-octadecylhydroxylamine and N,N-dialkylhydroxylamine from hydrogenated tallow fatty amines.

The group m) of the nitrones includes, for example, N-benzyl-α-phenylnitrone, N-ethyl-α-methylnitrone, N-octyl-α-heptylnitrone, N-lauryl-α-undecylnitrone, N-tetradecyl-α-tridecylnitrone, N-hexadecyl-α-pentadecylnitrone, N-octadecyl-α-heptadecylnitrone, N-hexadecyl-α-heptadecylnitrone, N-octadecyl-α-pentadecylnitrone, N-heptadecyl-α-heptadecylnitrone, N-octadecyl-α-hexadecylnitrone, N-methyl-α-heptadecyInitrone and nitrones derived from N,N-dialkylhydroxylamines prepared from hydrogenated tallow fatty amines.

The group n) of the amine oxides includes, for example, amine oxide derivatives as disclosed in U.S. Pat. Nos. 5,844,029 and 5,880,191, didecylmethylamine oxide, tridecylamine oxide, tridodecylamine oxide and trihexadecylamine oxide.

The group o) of the benzofuranones and indolinones includes, for example, those disclosed in U.S. Pat. Nos. 4,325,863, 4,338,244, 5,175,312, 5,216,052 or 5,252,643, in DE-A-4316611, in DE-A-4316622, in DE-A-4316876, in EP-A-0589839 or in EP-A-0591102 or 3-[4-(2-acetoxyethoxy)phenyl]-5,7-di(tert-butyl)benzofuran-2(3H)one, 5,7-di(tert-butyl)-3-[4-(2-stearoyloxyethoxy)phenyl]benzofuran-2(3H)-one, 3,3′-bis[5,7-di(tert-butyl)-3-(4-[2-hydroxyethoxy]phenyl)benzofuran-2(3H)-one], 5,7-di(tert-butyl)-3-(4-ethoxyphenyl)benzofuran-2(3H)-one, 3-(4-acetoxy-3,5-dimethylphenyl)-5,7-di(tert-butyl)benzofuran-2(3H)-one, 3-(3,5-dimethyl-4-pivaloyloxyphenyl)-5,7-di(tertbutyl)benzofuran-2(3H)-one, 3-(3,4-dimethylphenyl)-5,7-di(tert-butyl)benzofuran-2(3H)one, Irganoxs HP-136 from Ciba Specialty Chemicals and 3-(2,3-dimethylphenyl)-5,7-di(tert-butyl)benzofuran-2(3H)-one.

The group p) of the thiosynergists includes, for example, dilauryl thiodipropionate or distearyl thiodipropionate.

The group q) of the peroxide-destroying compounds includes, for example, esters of β-thiodipropionic acid, for example the lauryl, stearyl, myristyl or tridecyl ester, mercaptobenzimidazole or the zinc salt of 2-mercaptobenzimidazole, zinc dibutyldithiocarbamate, dioctadecyl disulfide or pentaerythritol tetrakis(β-dodecylmercaptopropionate).

The aqueous dispersions to be used according to the invention can also comprise, in addition to the wax constituents, one or more active substances suitable for protecting wood or comparable lignocellulose materials from attack or destruction by harmful organisms.

Examples of such harmful organisms are:
wood-discoloring fungi, e.g. Ascomycetes, such as Ophiostoma sp. (e.g. Ophiostoma piceae, Ophiostoma piliferum), Ceratocystis sp. (e.g. Ceratocystis coerulescens), Aureobasidium pullulans, Sclerophoma sp. (e.g. Sclerophoma pityophila); Deuteromycetes, such as Aspergillus sp. (e.g. Aspergillus niger), Cladosporium sp. (e.g. Cladosporium sphaerospermum), Penicillium sp. (e.g. Penicillium funiculosum), Trichoderma sp. (e.g. Trichoderma viride), Alternaria sp. (e.g. Alternaria alternata), Paecilomyces sp. (e.g. Paecilomyces variotii); Zygomycetes, such as Mucor sp. (e.g. Mucor hiemalis);
wood-destroying fungi: Ascomycetes, such as Chaetomium sp. (e.g. Chaetomium globosum), Humicola sp. (e.g. Humicola grisea), Petriella sp. (e.g. Petriella setifera), Trichurus sp. (e.g. Trichurus spiralis); Basidiomycetes, such as Coniophora sp. (e.g. Coniophora puteana), Coriolus sp. (e.g. Coriolus versicolor), Gloeophyllum sp. (e.g. Gloeophyllum trabeum), Lentinus sp. (e.g. Lentinus lepideus), Pleurotus sp. (e.g. Pleurotus ostreatus), Poria sp. (e.g. Poria placenta, Poria vaillantii), Serpula sp. (e.g. Serpula lacrymans) and Tyromyces sp. (e.g. Tyromyces palustris), and
wood-destroying insects, e.g. Cerambycidae, such as Hylotrupes bajulus, Callidium violaceum; Lyctidae, such as Lyctus linearis, Lyctus brunneus; Bostrichidae, such as Dinoderus minutus; Anobiidae, such as Anobium punctatum, Xestobium rufovillosum; Lymexylidae, such as Lymexylon navale; Platypodidae, such as Platypus cylindrus; Oedemeridae, such as Nacerda melanura; Formicidae, such as Camponotus abdominalis, Lasius flavus, Lasius brunneus, Lasius fuliginosus.

Fungicidal active substances, insecticidal active substances and bactericides are accordingly suitable, in particular:

Fungicides from the Following Groups:
dicarboximides, such as iprodione, myclozolin, procymidone or vinclozolin;
acylalanines, such as benalaxyl, metalaxyl, ofurace or oxadixyl;
amine derivatives, such as aldimorph, dodine, dodemorph, fenpropimorph, fenpropidin, guazatine, iminoctadine, spiroxamine or tridemorph;
anilinopyrimidines, such as pyrimethanil, mepanipyrim or cyprodinil;
antibiotics, such as cycloheximide, griseofulvin, kasugamycin, natamycin, polyoxin or streptomycin;
azoles (conazoles), such as azaconazole, bitertanol, bromoconazole, cyproconazole, diclobutrazole, difenoconazole, diniconazole, epoxiconazole, fenbuconazole, fluquinconazole, flusilazole, flutriafol, ketoconazole, hexaconazole, imazalil, metconazole, myclobutanil, penconazole, propiconazole, prochloraz, prothioconazole, tebuconazole, tetraconazole, triadimefon, triadimenol, triflumizole or triticonazole;
dithiocarbamates: ferbam, nabam, maneb, mancozeb, metam, metiram, propineb, polycarbamate, thiram, ziram or zineb;
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophanate-methyl, tiadinil, tricyclazole or triforine;
nitrophenyl derivatives, such as binapacryl, dinocap, dinobuton or nitrothal-isopropyl;
phenylpyrroles, such as fenpiclonil and fludioxonil;
2-methoxybenzophenones, such as are disclosed in EP-A 897 904 by the general formula I, e.g. metrafenone;
unclassified fungicides, such as acibenzolar-5-methyl, benthiavalicarb, carpropamid, chlorothalonil, cymoxanil, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, tolclofos-methyl, quintozene or zoxamide;
strobilurins, such as are disclosed in WO 03/075663 by the general formula I, e.g.: azoxystrobin, dimoxystrobin, fluoxastrobin, kresoxim-methyl, metominostrobin, orysastrobin, picoxystrobin, pyraclostrobin and trifloxystrobin;
sulfenic acid derivatives, such as captafol, captan, dichlofluanid, folpet or tolylfluanid;
cinnamamides and analogous compounds, such as dimethomorph, flumetover or flumorph;
6-aryl-[1,2,4]triazolo[1,5-a]pyrimidines, such as are disclosed, e.g., in WO 98/46608, WO 99/41255 or WO 03/004465, in each case by the general formula I;
amide fungicides, such as cyflufenamid and (Z)-N-[α-(cyclopropylmethoxyimino)-2,3-difluoro-6-(difluoromethoxy)benzyl]-2-phenylacetamide;
iodo compounds, such as diiodomethyl p-tolyl sulfone, 3-iodo-2-propynyl alcohol, (4-chlorophenyl)(3-iodopropargyl)formaldehyde, 3-bromo-2,3-diiodo-2-propenyl ethyl carbonate, 2,3,3-triiodoallyl alcohol, 3-bromo-2,3-diiodo-2-propenyl alcohol, 3-iodo-2-propynyl (n-butyl)carbamate, 3-iodo-2-propynyl (n-hexyl)carbamate, 3-iodo-2-propynyl phenylcarbamate, O-1-(6-iodo-3-oxohex-5-ynyl) butylcarbamate, O-1-(6-iodo-3-oxohex-5-ynyl)phenylcarbamate or nopcocide;
phenol derivatives, such as tribromophenol, tetrachlorophenol, 3-methyl-4-chlorophenol, dichlorophen, o-phenylphenol, m-phenylphenol or 2-benzyl-4-chlorophenol;
isothiazolinones, such as N-methylisothiazolin-3-one, 5-chloro-N-methylisothiazolin-3-one, 4,5-dichloro-N-octylisothiazolin-3-one or N-octylisothiazolin-3-one;
(benz)isothiazolinones, such as 1,2-benzisothiazol-3(2H)-one, 4,5-dimethylisothiazol-3-one or 2-octyl-2H-isothiazol-3-one;
pyridines, such as 1-hydroxy-2-pyridinethione (and their Na, Fe, Mn or Zn salts), or tetrachloro-4-(methylsulfonyl)pyridine;
metal soaps, such as tin, copper or zinc naphthenate, octate, 2-ethylhexanoate, oleate, phosphate or benzoate;
organotin compounds, e.g. tributyltin (TBT) compounds, such as tributyltin and tributyl(mononaphthenoyloxy)tin derivatives;
dialkyldithiocarbamate and the Na and Zn salts of dialkyldithiocarbamates, or
tetramethylthiuram disulfide;
nitriles, such as 2,4,5,6-tetrachloroisophthalodinitrile;
benzothiazoles, such as 2-mercaptobenzothiazole; quinolines, such as 8-hydroxyquinoline, and their Cu salts;
tris(N-cyclohexyldiazeniumdioxy)aluminum, (N-cyclohexyldiazeniumdioxy)tributyltin or bis(N-cyclohexyldiazeniumdioxy)copper;
3-(benzo(b)thien-2-yl)-5,6-dihydro-1,4,2-oxathiazin 4-oxide (bethoxazin).
   Insecticides from the Following Groups:
organophosphates, such as azinphos-methyl, azinphos-ethyl, chlorpyrifos, chlorpyrifos-methyl, chlorfenvinphos, diazinon, dimethylvinphos, dioxabenzofos, disulfoton, ethion, EPN, fenitrothion, fenthion, heptenophos, isoxathion, malathion, methidathion, methyl parathion, paraoxon, parathion, phenthoate, phosalone, phosmet, phorate, phoxim, pirimiphos-methyl, profenofos, prothiofos, pirimiphos-ethyl, pyraclofos, pyridaphenthion, sulprofos, triazophos, trichlorfon, tetrachlorvinphos or vamidothion;
carbamates, such as alanycarb, benfuracarb, bendiocarb, carbaryl, carbofuran, carbosulfan, fenoxycarb, furathiocarb, indoxacarb, methiocarb, pirimicarb, propoxur, thiodicarb or triazamate;
pyrethroids, such as bifenthrin, cyfluthrin, cycloprothrin, cypermethrin, deltamethrin, esfenvalerate, etofenprox, fenpropathrin, fenvalerate, cyhalothrin, lambda-cyhalothrin, permethrin, silafluofen, tau-fluvalinate, tefluthrin, tralomethrin or alpha-cypermethrin;
arthropodal growth regulators: a) chitin synthesis inhibitors, e.g. benzoylureas, such as chlorfluazuron, diflubenzuron, flucycloxuron, flufenoxuron, hexaflumuron, lufenuron, novaluron, teflubenzuron, triflumuron, buprofezin, diofenolan, hexythiazox, etoxazole or clofentezine; b) ecdysone antagonists, such as halofenozide, methoxyfenozide or tebufenozide; c) juvenile hormone mimics, such as pyriproxyfen or methoprene; d) lipid biosynthesis inhibitors, such as spirodiclofen;
neonicotinoids, such as flonicamid, clothianidin, dinotefuran, imidacloprid, thiamethoxam, nithiazine, acetamiprid or thiacloprid;
additional unclassified insecticides, such as abamectin, acequinocyl, amitraz, azadirachtin, bifenazate, cartap, chlorfenapyr, chlordimeform, cyromazine, diafenthiuron, diofenolan, emamectin, endosulfan, fenazaquin, formetanate, formetanate hydrochloride, hydramethylnon, indoxacarb, piperonyl butoxide, pyridaben, pymetrozine, spinosad, thiamethoxam, thiocyclam, pyridalyl, fluacrypyrim, milbemectin, spiromesifen, flupyrazofos, NCS 12, flubendiamide, bistrifluoron, benclothiaz, pyrafluprole, pyriprole, amidoflumet, flufenerim, cyflumetofen, lepimectin, profluthrin, dimefluthrin and metaflumizone; and

Bactericides: e.g. isothiazolones, such as 1,2-benzisothiazol-3(2H)-one (BIT), mixtures of 5-chloro-2-methyl-4-isothiazolin-3-one with 2-methyl-4-isothiazolin-3-one and also 2-(n-octyl)-4-isothiazolin-3-one (OIT), furthermore carbendazim, chlorotoluron, 2,2-dibromo-3-nitrilopropionamide (DBNPA), fluometuron, 3-iodo-2-propynyl butylcarbamate (IPBC), isoproturon, prometryn or propiconazole.

The wax dispersions can comprise the active substance(s) or effect substance(s), if present, in dissolved or dispersed form or, preferably, in the particles of the wax component.

The concentration of active or effect substance in the wax dispersion depends in a way known per se on the purpose desired for the application and typically ranges from 0.01 to 50% by weight, in particular from 0.1 to 15% by weight, based on the wax component, or from 0.03 to 5% by weight, based on the total weight of the dispersion. For colorants, the concentration typically ranges from 0.1 to 10% by weight, based on the weight of the dispersion; for active substances, the concentration typically ranges from 0.01 to 5% by weight; for UV stabilizers, the concentration typically ranges from 0.1 to 5% by weight; and, for antioxidants, the concentration typically ranges from 0.1 to 5% by weight, based on the weight of the dispersion.

According to an additional preferred embodiment of the invention, the aqueous wax dispersion additionally comprises, in addition to the wax constituent and, if appropriate, the active and/or effect substances, at least one crosslinkable compound, so that steps a) and b) of the process according to the invention can be carried out together.

With regard to the type of the crosslinkable compound, to the type and amount of the hydrophobizing agent and to the other constituents present in the hydrophobizing agent, including to the catalysts used for the crosslinking, that said previously is similarly valid, in particular with regard to the preferences, unless otherwise stated.

If present, the concentration of the crosslinkable compounds in the aqueous wax dispersion usually ranges from 5 to 30% by weight, frequently ranges from 5 to 20% by weight and in particular ranges from 10 to 20% by weight, based on the total weight of the dispersion. If the dispersion comprises one of the abovementioned alcohols, the concentration of the alcohol preferably ranges from 1 to 10% by weight, in particular ranges from 3 to 8% by weight.

If the aqueous dispersion exhibits one of the abovementioned crosslinkable compounds, it generally comprises a catalyst K which brings about the crosslinking of the compound V or of its reaction product or precondensate. The catalyst K will usually be added to the aqueous dispersion only shortly before the impregnation of the lignocellulose material. The concentration of the catalyst, based on the total weight of the aqueous dispersion, usually ranges from 0.1 to 10% by weight and in particular ranges from 0.5 to 5% by weight.

The impregnation of the lignocellulose material with the hydrophobizing agent depends, in a way known per se, on the hydrophobizing agent used each time. Oils and liquid hydrophobizing agents are preferably incorporated in the lignocellulose material according to the Ruping process or the Royal process.

In the case of aqueous preparations of the hydrophobizing agent, in particular aqueous wax dispersions, the impregnation succeeds in a way which is conventional per se for this, e.g. by immersion, by combined application of vacuum with pressure or, in particular in the case of finely divided lignocellulose materials, also by conventional application methods, such as spreading, spraying and the like. The impregnation method used in each case naturally depends on the dimensions of the material to be impregnated. Lignocellulose materials having small dimensions, such as chips or strands, and also thin veneers, i.e. materials with a high ratio of surface area to volume, can be impregnated cheaply, e.g. by immersion or spraying, whereas lignocellulose materials having greater dimensions, in particular materials having a smallest extension of more than 5 mm, e.g. solid wood or moldings made of solid wood, are impregnated by application of pressure, in particular by combined application of pressure and vacuum. In contrast to the state of the art, the application of elevated temperature is unnecessary in principle. The impregnation is advantageously carried out at a temperature of less than 50° C., e.g. in the range from 15 to 50° C.

For immersion, the lignocellulose material, if appropriate after predrying, is immersed in a container comprising the aqueous wax dispersion. The immersion is preferably carried out over a period of time from a few seconds to 24 h, in particular 1 min to 6 h. The temperatures usually range from 15° C. to 50° C. Doing this, the lignocellulose material takes up the aqueous wax dispersion, it being possible for the amount of the nonaqueous constituents (i.e. wax, if appropriate active and/or effect substances and, if appropriate, curable constituents) taken up by the lignocellulose material to be controlled by the concentration of these constituents in the aqueous composition, by the temperature and by the duration of treatment. The amount of constituents actually taken up can be determined and controlled by a person skilled in the art in a simple way via the increase in weight of the lignocellulose material and the concentration of the constituents in the aqueous dispersion. Veneers can, for example, be prepressed using press rolls, i.e. calenders, which are present in the aqueous impregnation composition. The vacuum occurring in the lignocellulose material on relaxation then results in an accelerated uptake of aqueous wax dispersion.

The impregnation with the wax dispersion is advantageously carried out by combined application of reduced and increased pressure. For this, the lignocellulose material, which generally exhibits a moisture content in the range from 1% to 100%, is first brought into contact with the aqueous composition, e.g. by immersion in the aqueous composition, under a reduced pressure which is frequently in the range from 10 to 500 mbar and in particular in the range from 40 to 100 mbar. The duration is usually in the range from 1 min to 1 h. This is followed by a phase at increased pressure, e.g. in the range from 2 to 20 bar, in particular in the range from 4 to 15 bar and especially from 5 to 12 bar. The duration of this phase is usually in the range from 1 min to 12 h. The temperatures are usually in the range from 15 to 50° C. Doing this, the lignocellulose material takes up the aqueous wax dispersion, it being possible for the amount of the nonaqueous constituents (i.e. wax, if appropriate active and/or effect substances and, if appropriate, curable constituents) taken up by the lignocellulose material to be controlled by the concentration of these constituents in the aqueous composition, by the pressure, by the temperature and by the duration of treatment. The amount actually taken up can also here be calculated via the increase in weight of the lignocellulose material.

Furthermore, the impregnation can be carried out by conventional methods for applying liquids to surfaces, e.g. by spraying or rolling or spreading. With regard to this, use is advantageously made of a veneer with a moisture content of not more than 50%, in particular not more than 30%, e.g. in the range from 12% to 30%. The application is usually carried out at temperatures in the range from 15 to 50° C. The spraying can be carried out in the usual way in all devices suitable for the spraying of flat or finely divided bodies, e.g. using nozzle arrangements and the like. For spreading or rolling, the desired amount of aqueous composition is applied to the flat material with rolls or brushes.

If the aqueous wax dispersion used according to the invention comprises a crosslinkable compound, as described above, a drying step and, if appropriate, a curing step at elevated temperature can follow the impregnating. However, in principle, a further processing of the impregnated material can also be carried out immediately after the impregnating. This is particularly suitable if the impregnated lignocellulose material is a finely divided material which is further processed with glue to give moldings, such as OSB (oriented structural board) boards, particle boards, wafer boards, OSL (oriented strand lumber) boards and OSL moldings, PSL (parallel strand lumber) boards and PSL moldings, insulating boards, medium-density (MDF) and high-density (HDF) fiber boards, wood-plastic composites (WPC) and the like, or a veneer which is further processed to give veneer lumber.

If a curing step is carried out, it is carried out by heating the impregnated material at temperatures of at least 80° C., in particular of greater than 90° C., e.g. in the range from 90 to 220° C. and in particular in the range from 100 to 200° C. If appropriate, it is possible to carry out a separate drying step beforehand. In this connection, the volatile constituents of the aqueous composition, in particular the water and excess organic solvents which do not react in the curing/crosslinking of the urea compounds, are partially or completely removed. The term “predrying” means, in this context, that the lignocellulose material is dried to below the fiber saturation point, which, depending on the type of the material, is approximately 30% by weight. This predrying counteracts, for large-scale bodies, in particular for solid wood, the danger of cracking. For small-scale materials or veneers, the predrying is generally omitted. For materials having greater dimensions, the predrying is advantageous, however. If a separate predrying is carried out, this is advantageously carried out at temperatures in the range from 20 to 80° C. Depending on the drying temperature chosen, partial or complete curing/crosslinking of the curable constituents present in the composition can occur. The combined predrying/curing of the impregnated materials is usually carried out by application of a temperature profile which can extend from 50° C. to 220° C., in particular from 80 to 200° C.

However, drying and curing will frequently be carried out in one step. The curing/drying can be carried out in a conventional fresh air-outgoing air system. The predrying is preferably carried out in a way that the moisture content of the impregnated lignocellulose materials after the predrying is not more than 30%, in particular not more than 20%, based on the dry weight. It can be advantageous to take the drying/curing to a moisture content <10% and in particular <5%, based on the dry weight. The moisture content can be controlled in a simple way by the temperature, the duration and the pressure chosen in the predrying.

The lignocellulose materials treated according to the invention can, if ready-made final products are not already concerned, be further processed in a way known per se, in the case of finely divided materials, e.g., to give moldings, such as OSB (oriented structural board) boards, particle boards, wafer boards, OSL (oriented strand lumber) boards and OSL moldings, PSL (parallel strand lumber) boards and PSL moldings, insulating boards and medium-density (MDF) and high-density (HDF) fiber boards, wood-plastic composites (WPC) and the like, in the case of veneers, to give veneer lumber, such as veneered fiber boards, veneered CLV boards, veneered particle boards, including veneered OSL (oriented strand lumber) and PSL (parallel strand lumber) boards, plywood, glued wood, laminated wood, veneered laminated wood (e.g. Kerto laminated wood), multiplex boards, laminated veneer lumber (LVL), decorative veneer lumber, such as lining, ceiling and prefabricated parquet panels, but also nonplanar, three-dimensionally shaped components, such as laminated wood moldings, plywood moldings and any other molding laminated with at least one layer of veneer. The further processing can be carried out immediately after the impregnation with the hydrophobizing agent or, if the curing is carried out after the treatment with the hydrophobizing agent, during or after the curing. In the case of impregnated veneers, the further processing is advantageously carried out before the curing step or together with the curing step. For moldings made of finely divided materials, the molding step and curing step are comprehensively carried out simultaneously.

If the lignocellulose material which can be obtained according to the invention is solid wood or a ready-made derived timber product, this can be worked in the usual way before or after the hydrophobizing, e.g. by sawing, planing, grinding, coating, and the like. Impregnated and cured solid wood according to the invention is suitable in particular for the preparation of objects which are subject to humidity and in particular the effects of the weather, e.g. for structural timbers, beams, structural elements made of wood, for wooden balconies, roof shingles, fences, wooden posts, railroad ties or in shipbuilding for the interior finish and superstructure.

The following examples serve to illustrate the invention and are not to be understood as limiting.

### EXAMPLE 1

### Unpressurized Impregnation with Colored Wax Dispersion with Crosslinking Agents

A wax dispersion was prepared by emulsifying 21.7 parts by weight of a montan wax/emulsifier mixture colored with Sudan blue 670 (melting point of the wax, ca. 78-83° C., 1% by weight of dye, based on wax, alkyl ethoxylate as emulsifier) in 78.3 parts by weight of water at 95° C. 50 parts by weight of the wax dispersion thus obtained were mixed with 30 parts by weight of a concentrated aqueous composition of N,N-bis(hydroxymethyl)-4,5-bishydroxyimidazolin-2-one (Fixapret CP from BASF), 1.5 parts by weight of MgCl₂.6H₂O and 17.5 parts by weight of water.

The cubes of pinewood to be investigated were, before impregnating, sealed on their faces with a 2K varnish, stored in a drying cabinet at 103° C. for 16 h and subsequently cooled in a desiccator over a drying agent. The weight and the dimensions of the cubes of wood were determined before the investigation.

A cube of wood prepared in this way was, in a pressure-resistant vessel, in each case loaded with a weight and immersed in the abovedescribed wax emulsion. The pressure was subsequently lowered in 10 min to 60 mbar absolute and the vacuum was subsequently maintained for 1 h. The vacuum was then relieved to standard pressure and the cubes of wood were left in the wax emulsion for a further 4 h. The wet pieces of wood were placed in a simmering and baking foil. This was closed and provided with a small hole and subsequently stored in a drying cabinet at 120° C. for 36 h. The cubes of wood were subsequently allowed to cool in a desiccator over drying agent and the weight and the dimensions were again determined. The change in weight was 15.6%. The change in size was 0.8% with regard to the width and 0.1% with regard to the height. On sawing the cube, marked penetration of the blue color into the inside of the cube appeared.

### EXAMPLE 2

### Impregnation Under Pressure

The wax dispersion described in example 1 was investigated. The small wooden blocks were prepared as described in example 1.

A prepared cube of pinewood was, in a pressure-resistant vessel, loaded with a weight and immersed in the abovedescribed wax emulsion. The pressure was subsequently lowered in 10 min to 60 mbar absolute and the vacuum was subsequently maintained for 1 h. The vacuum was then relieved to standard pressure and the piece of wood to be tested and the wax emulsion were transferred into an autoclave and were stored at an absolute pressure of 6 bar for 1 h. The pressure was subsequently relaxed and the cubes of wood were left in the wax emulsion for a further 4 h. The wet pieces of wood were placed in a simmering and baking foil. This was closed and provided with a small hole and subsequently stored in a drying cabinet at 120° C. for 36 h. The cubes of wood were subsequently allowed to cool in a desiccator over drying agent and the weight and the dimensions were again determined. The change in weight was 17%. The change in size was 1.2% with regard to the width and 0% with regard to the height. On sawing the cube, considerable penetration of the blue color into the inside of the cube appeared.

1. A process for the hydrophobizing of lignocellulose materials by impregnation of the lignocellulose material with a hydrophobizing agent, which comprises impregnating the lignocellulose material, before or during the hydrophobizing, with a curable aqueous composition comprising at least one crosslinkable compound chosen is selected from the group consisting of
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V, and
γ) reaction products or mixtures of the compound V with at least one alcohol selected from C₁-C₆-alkanols, C₂-C₆-polyols and oligo-C₂-C₄-alkylene glycols.

2. The process according to claim 1, wherein the hydrophobizing agent comprises at least one wax or one waxy polymer.

3. The process according to claim 2, wherein the hydrophobizing agent is an aqueous dispersion of the wax or waxy polymer.

4. The process according to claim 2, wherein the particles of the wax component exhibit a melting point of at least 75° C.

5. The process according to claim 3, wherein the particles of the dispersed wax component exhibit a mean particle size of less than 500 nm.

6. The process according to claim 1, wherein the crosslinkable compound is at least one selected from the group consisting of
1,3-bis(hydroxymethyl)-4,5-dihydroxyimidazolidin-2-one,
1,3-bis(hydroxymethyl)-4,5-dihydroxyimidazolidin-2-one modified with a C₁-C₆-alkanol, a C₂-C₆-polyol and/or an oligoalkylene glycol,
1,3-bis(hydroxymethyl)urea,
1,3-bis(methoxymethyl)urea,
1-hydroxymethyl-3-methylurea,
1,3-bis(hydroxymethyl)imidazolidin-2-one (dimethylolethyleneurea),
1,3-bis(hydroxymethyl)-1,3-hexahydropyrimidin-2-one
(dimethylolpropyleneurea), -1,3-bis(methoxymethyl)-4,5-dihydroxyimidazolidin-2-one (DMeDHEU),
tetra(hydroxymethyl)acetylenediurea,
low molecular weight melamine-formaldehyde resins, and
low molecular weight melamine-formaldehyde resins which are modified with a C₁-C₆-alkanol, a C₂-C₆-polyol and/or an oligoalkylene glycol (modified MF resin).

7. The process according to claim 1, wherein the concentration of crosslinkable compound in the aqueous curable composition ranges from 1 to 60% by weight, based on the total weight of the composition.

8. The process according to claim 1, wherein the aqueous composition additionally comprises a catalyst which brings about the curing of the crosslinkable compound.

9. The process according to claim 8, additionally comprising a curing of the crosslinkable compound at elevated temperature.

10. The process according to claim 9, wherein the hydrophobizing is carried out after the curing.

11. The process according to claim 1, wherein the hydrophobizing and the impregnation with the aqueous composition of the curable compound are carried out simultaneously.

12. The process according to claim 11, wherein the aqueous composition comprises the hydrophobizing agent in dispersed form.

13. The process according to claim 12, wherein the impregnation is carried out by successive application of reduced and increased pressure.

14. The process according to claim 1, wherein the impregnation is carried out at a temperature of less than 50° C.

15. The process according to claim 1, wherein the lignocellulose material is wood or a derived timber product.

16. A lignocellulose material, which is obtained by a process according to claim 1.

17. An aqueous composition, comprising
a) at least one hydrophobizing agent dispersed in the aqueous phase and
b) at least one crosslinkable compound selected from the group consisting of
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol chosen from C₁-C₆-alkanols, C₂-C₆-polyols and oligo-C₂-C₄-alkylene glycols;
wherein the aqueous composition comprises the hydrophobizing agent in an amount of 5 to 40% by weight, based on the total amount of the aqueous composition.

18. The dispersion according to claim 17, wherein the hydrophobizing agent dispersed in the aqueous phase is a wax or a waxy polymer.

19. The dispersion according to claim 18, wherein the particles of the hydrophobizing agent exhibit a melting point of at least 75° C.

20. The dispersion according to claim 17, wherein the particles of the dispersed hydrophobizing agent exhibit a mean particle size of less than 500 nm.
